(19) United States
(12) Patent Application Publication
(10) Pub. No.: US 2026/0089288 A1
(43) Pub. Date: Mar. 26, 2026

(54) STORAGE MEDIUM STORING APPLICATION PROGRAM, AND METHOD

(71) Applicant: CANON KABUSHIKI KAISHA, Tokyo (JP)

(72) Inventor: MASATO KOBAYASHI, Chiba (JP)

(21) Appl. No.: 19/327,357

(22) Filed: Sep. 12, 2025

(30) Foreign Application Priority Data
Sep. 24, 2024 (JP) 2024-165077

(51) Int. Cl. H04N 1/60

(52) U.S. Cl. CPC H04N 1/6075

(57) ABSTRACT

A an application program supporting a standard driver which has been supplied from a supplier of an operating system and has been incorporated in the operating system in advance. The application program causes a computer to execute a display control step of displaying a setting reception screen for receiving a setting of saturation of an image generated by a scan function of the image processing apparatus, and an output step of outputting the setting received on the setting reception screen.

### BACKGROUND

### Field of the Technology

The present disclosure relates to a storage medium storing an application program, and a method.

### Description of the Related Art

To a scanning device (scanner) that performs image reading, i.e. scanning, a host computer (information processing apparatus) that is capable of processing information between the same and the scanning device is communicably connected. As control software for controlling the scanning device, for example, a scan driver installed from the scanning device into the host computer is used.

With this scan driver, it is possible to provide a scan instruction from the host computer to the scanning device. In the host computer, an operating system (hereinafter referred to as the “OS”) as basic software is installed in advance. The scan driver is configured according to specifications defined by the OS and can operate when called from the OS. Further, the scan driver is different for each vendor that supplies a scanning device, i.e. is a model specific scan driver which is suitable on a scanning device basis.

In recent years, in Windows (registered trademark), a standard class driver (hereinafter sometimes referred to as the “standard driver”) is provided, which can be commonly used even for scanning devices supplied from respective different vendors. The standard driver is incorporated in the OS in advance. Then, by connecting a desired scanning device to a host computer having the OS incorporating the standard driver, the standard driver can be used. This makes it possible to omit installation of a model-specific scan driver. Further, it is assumed that the standard driver is configured to enable designation of a scan function of the scanning device according to scan function information generated based on information acquired from the scanning device. This makes it possible to designate a scan function for each scanning device by one standard driver.

The standard driver can be commonly used for the scanning devices of a plurality of different vendors, and hence, for example, there is a case where it is impossible to cause a scanning device of a predetermined vendor to execute part of functions of this scanning device. Japanese Laid-Open Patent Publication No. 2021-033526 discloses a program that extends a print function of a print service which can be used for general purpose regardless of a model or vendor of the image forming apparatus. With this, by operating a print setting screen adapted to an individual image forming apparatus on a model basis and on a vendor basis, it is possible to cause the image forming apparatus to execute a print function which cannot be executed if only the print service is used which can be used for general purpose.

As described above, the scan driver is different on a scanning device vendor, i.e. is a model specific scan driver which is suitable on a scanning device basis. The scan driver has a function of adjusting saturation and hue for an image to be scanned, when providing a scan instruction. However, the standard driver has a problem of being incapable of adjusting saturation and hue for the image to be scanned, when providing a scan instruction.

### SUMMARY

The present disclosure provides a mechanism capable of adjusting saturation and hue for an image generated by a scan function.

In a first aspect of the present disclosure, there is provided a non-transitory computer-readable storage medium storing an application program supporting a standard driver which has been supplied from a supplier of an operating system and has been incorporated in the operating system in advance, wherein the application program causes a computer to execute a display control step of displaying a setting reception screen for receiving a setting of saturation of an image generated by a scan function of the image processing apparatus, and an output step of outputting the setting received on the setting reception screen.

In a second aspect of the present disclosure, there is provided a non-transitory computer-readable storage medium storing an application program supporting a standard driver which has been supplied from a supplier of an operating system and has been incorporated in the operating system in advance, wherein the application program causes a computer to execute a display control step of displaying a setting reception screen for receiving a setting of saturation of an image generated by a scan function of the image processing apparatus, an acquisition step of acquiring the image generated by the scan function from the image processing apparatus, and an execution step of executing processing based on the setting received on the setting reception screen, on the image acquired in the acquisition step.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram showing a hardware configuration of a scan system according to a first embodiment.

FIGS. 2A and 2B are block diagrams each showing a software configuration of the scan system.

FIGS. 3A to 3D are diagrams each showing an example of a screen displayed on a display section of the scan system.

FIG. 4 is a flowchart of a process performed by a scan function-extending unit, for editing scan function information.

FIGS. 5A to 5C are diagrams each showing an example of a list of the scan information.

FIG. 6 is a sequence diagram showing a process executed between a scan application, general-purpose scan software, an extension application, and a scanning device, after the scan application receives a scan setting.

FIG. 7 is a flowchart of a process performed by the extension application.

FIG. 8 is a flowchart of a process performed by the scanning device.

FIG. 9 is a sequence diagram showing a process executed, in a second embodiment, between the scan application, the general-purpose scan software, the extension application, and the scanning device, after the scan application receives a scan setting.

FIG. 10 is a sequence diagram showing a process executed, in a third embodiment, between the scan application, the general-purpose scan software, the extension application, and the scanning device, after the scan application receives a scan setting.

FIG. 11 is a flowchart of a process performed by the extension application.

FIG. 12 is a flowchart of a process performed by the scan function-extending unit in a fourth embodiment, for editing the scan function information.

FIG. 13 is a diagram showing an example of a list of capabilities information of the scanning device.

FIG. 14 is a sequence diagram showing a process executed between the scan application, the general-purpose scan software, the extension application, and the scanning device, after the scan application receives a scan setting.

FIG. 15 is a sequence diagram showing a process executed, in a fifth embodiment, between the scan application, the general-purpose scan software, the extension application, and the scanning device, after the scan application receives a scan setting.

FIG. 16 is a sequence diagram showing a process executed, in a sixth embodiment, between the scan application, the general-purpose scan software, the extension application, and the scanning device, after the scan application receives a scan setting.

FIG. 17 is a diagram showing an example of a screen displayed on the display section of the scan system.

### DESCRIPTION OF THE EMBODIMENTS

The present disclosure will now be described in detail below with reference to the accompanying drawings showing embodiments thereof. The configuration described in the following embodiments is given, only by way of example, and is by no means intended to limit the scope of the present disclosure. For example, components of the configuration of the present disclosure can be replaced with desired components which can exhibit the same function. Further, desired components can be added. Further, two or more desired components (features) of the embodiments can be combined.

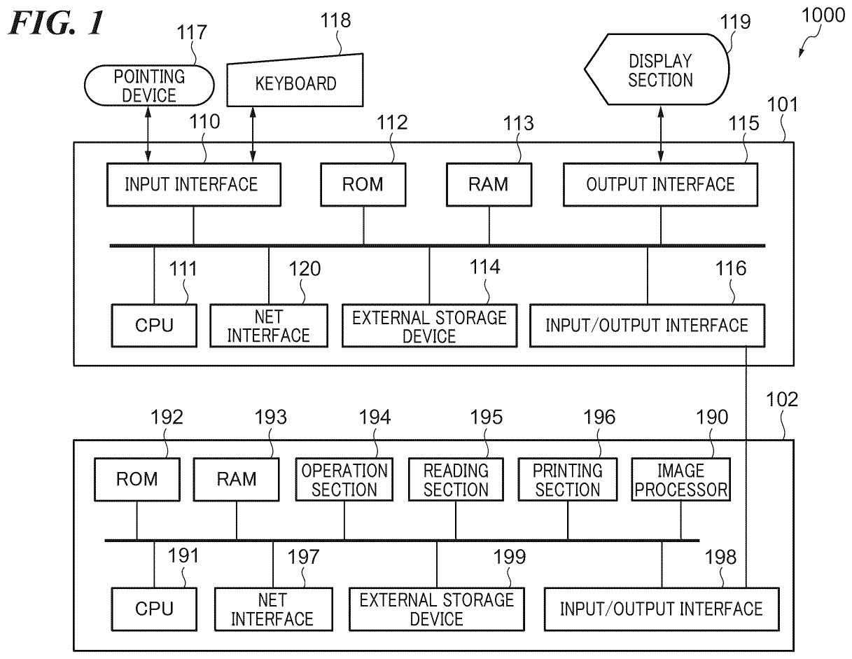

A first embodiment will be described below with reference to FIGS. 1 to 8.

FIG. 1 is a block diagram showing a hardware configuration of a scan system according to the first embodiment. As shown in FIG. 1, the scan system, denoted by reference numeral 1000, includes a host computer 101, a scanning device (scanner) 102, a pointing device 117, a keyboard 118, and a display section 119, and these are communicably connected to each other. The host computer 101 is an information processing apparatus, and includes an input interface 110, a central processing unit (CPU) 111, a read only memory (ROM) 112, a random access memory (RAM) 113, an external storage device (storage medium) 114, an output interface 115, an input/output interface 116, and a network (NET) interface 120. Note that, although as the host computer 101, for example, a desktop-type personal computer can be used, this is not limitative, but for example, a laptop-type personal computer, a tablet terminal, and a smartphone can be used.

The CPU 111 is a computer that executes e.g. programs stored in the ROM 112 and the external storage device 114. Note that in the present embodiment, the CPU 111 is capable of executing functions and processing of the host computer 101, i.e. steps (control method) and the like, described hereinafter, by performing processing according to a program code stored in the ROM 112. In the ROM 112, an initialization program is stored. In the external storage device 114, an application program group, an operating system (OS), print data generation software, and a variety of other data are stored. Note that in the present embodiment, as the OS, Windows (registered trademark) 11 of Microsoft Corporation (registered trademark) has been installed in the host computer 101. The external storage device 114 is not particularly limited, but for example, a hard disk drive (HDD) or a solid state drive (SSD) can also be used. The RAM 113 is used e.g. as a work memory when a variety of programs stored in the external storage device 114 are executed, and the variety of programs can operate in the host computer 101. To the input interface 110, the pointing device 117 and the keyboard 118 as input devices are connected. To the output interface 115, the display section 119 as a display device is connected. On the display section 119, for example, a scan setting screen 300A and a detailed setting screen 300C, described hereinafter, are displayed. The NET interface 120 is a network interface and performs control to transfer data to and from an external apparatus via a network. To the input/output interface 116, the scanning device 102 is connected. This enables the host computer 101 to communicate with the scanning devices 102 of a plurality of makers, i.e. process information between the host computer 101 and the scanning devices 102 of the plurality of makers, regardless of the maker of the scanning device 102. The host computer 101 and the scanning device 102 can be wired connected or can be wirelessly connected.

The scanning device 102 includes an image processor 190, a CPU 191, a ROM 192, a RAM 193, an operation section 194, a reading section 195, a printing section 196, a NET interface 197, an input/output interface 198, and an external storage device 199. The CPU 191 is a computer that executes e.g. programs stored in the ROM 192 and the external storage device 199 and performs centralized control of the scanning device 102. The ROM 192 is a memory for storing the programs. The RAM 193 is a memory for temporarily storing a program and image data. On the operation section 194, a variety of operation instructions can be provided to the scanning device 102. The reading section 195 reads an image from an original. The printing section 196 prints an image on a sheet e.g. based on image data generated by reading an image from an original in the reading section 195. Note that the printing section 196 can be omitted. The NET interface 197 is a network interface and performs control to transfer data to and from an external apparatus via a network. To the input/output interface 198, the host computer 101 is connected. To the image processor 190, for example, image data generated by reading an image from an original in the reading section 195 is input. Then, the image processor 190 performs various types of edit processing operations on the image data.

The scanning device 102 is not particularly limited insofar as it is an apparatus having an image reading function, i.e. a scan function, but, for example, an image processing apparatus, such as a multi-function peripheral (MFP), can be used. Further, in a case where the MFP is used as the scanning device 102, printing performed by the MFP is printing using the electrophotographic method in the present embodiment but is not limited to this, and, for example, printing using the inkjet method can be performed. Further, although in the present embodiment, the host computer 101 and the scanning device 102 are separately configured, this is not limitative. For example, the host computer 101 and the scanning device 102 can be configured as an integrated apparatus.

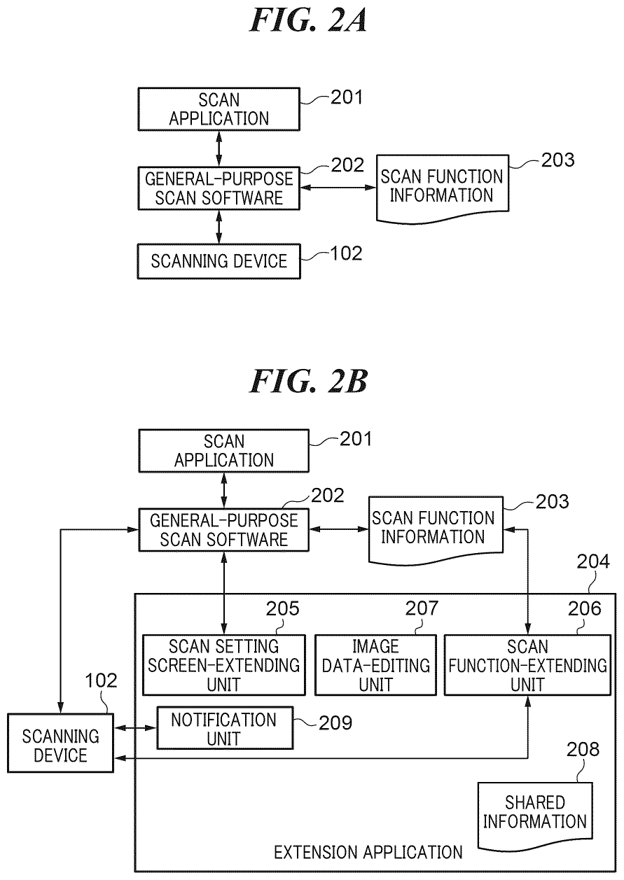

FIGS. 2A and 2B are block diagrams each showing a software configuration of the scan system 1000. FIG. 2A is a diagram showing a general configuration in a case where an extension application (application program) 204 is not associated with general-purpose scan software (standard driver) 202 and the scanning device 102. FIG. 2B is a diagram showing a configuration in a case where the extension application 204 is associated with the general-purpose scan software 202 and the scanning device 102. The general-purpose scan software 202 is a standard driver provided by a supplier of an OS and integrated into the OS. The standard driver is a class driver (general-purpose program) that can be used commonly e.g. during scan (during image reading), for scanning devices 102 of a plurality of makers. The standard driver is provided as one of functions in a package of the OS, together with the OS. The standard driver can perform processing for a variety of scanning devices by using a standardized scanning method. With this, the standard driver can generate and output an instruction which can be interpreted by the scanning devices 102 of the plurality of makers. Note that the standard driver is not particularly limited, but a program that operates based on Internet Printing Protocol (IPP). The general-purpose scan software 202 is installed (integrated) in the OS in advance.

The extension application 204 is a program which supports, i.e. assists the general-purpose scan software 202 (program for executing a control method for performing control to support the general-purpose scan software 202). In the present embodiment, the extension application 204 is an extension program which can extend functions which cannot be executed by the general-purpose scan software 202 for the scanning device 102, but is not limited to this. For example, the extension application 204 can be a program which improves the convenience of functions which can be executed by the general-purpose scan software 202 for the scanning device 102. The extension application 204 is stored e.g. in the external storage device 114 together with the OS (the general-purpose scan software 202). With this, the host computer 101 has the general-purpose scan software 202 and the extension application 204.

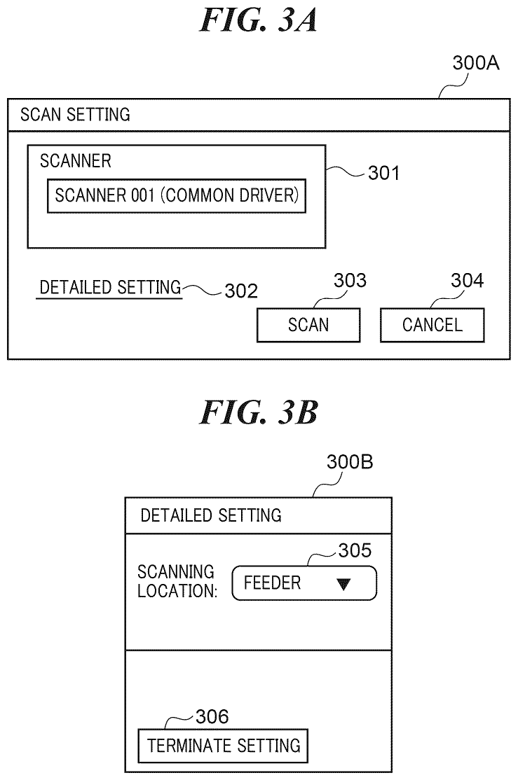

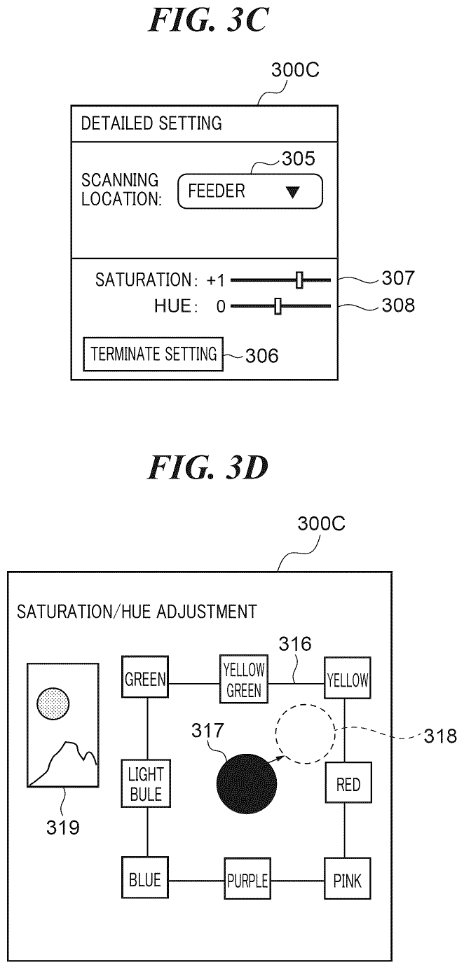

First, referring to FIG. 2A, the configuration in the case where the extension application 204 is not associated with the general-purpose scan software 202 and the scanning device 102 will be described. A scan application 201 is software for taking in contents (image data) generated by scanning performed by the scanning device 102. The scan application 201 is not particularly limited, but, for example, a document generation application and an image editing application are used. The scan application 201 issues a scan instruction to the OS e.g. upon receipt of a scan request from a user. The scan instruction includes scan setting information for instructing operations of the general-purpose scan software 202 and the scanning device 102. To issue a scan instruction, the scan application 201 can display the scan setting screen 300A provided by one of the general-purpose scan software 202, the OS, and the scan application 201, on the display section 119. Further, by operating (pressing) a control 302 in the scan setting screen 300A, the scan application 201 can display a detailed setting screen 300B (see FIG. 3B) on the display section 119. The scan setting screen 300A, the detailed setting screen 300B, and further, the detailed setting screen 300C will be described hereinafter. The scan setting screen 300A includes a setting item indicating a scan function which can be set according to capabilities information acquired by the general-purpose scan software 202, i.e. information which can be set as the scan setting, and a control item indicating its setting. The capabilities information refers to information related to the capabilities of the scanning device 102 for performing scan. Further, with this capabilities information, it is also possible to determine whether or not information which enables the display of the detailed setting screen 300C is included (determination step). Then, as a result of this determination, if it is determined that the information which enables the display of the detailed setting screen 300C is included, the detailed setting screen 300C can be displayed. On the other hand, if it is determined that the information which enables the display of the detailed setting screen 300C is not included, the display of the detailed setting screen 300C is inhibited. Thus, the extension application 204 can switch whether or not to display the detailed setting screen 300C according to the capabilities information of the scanning device 102.

Scan function information 203 is data indicating all scan functions which can be set, settings of these scan functions, and a scan function describing e.g. an exclusive relation between settings. The scan function information 203 is included in a configuration file of the general-purpose scan software 202 and is disposed in the external storage device 114 as an unchangeable file.

Alternatively, the scan function information 203 is dynamically generated by the general-purpose scan software 202. Specifically, the general-purpose scan software 202 acquires attribute data of the scanning device 102 from the scanning device 102. The general-purpose scan software 202 generates the scan function information 203 according to attribute information in the attribute data. Note that in a case where the scan function information 203 is dynamically generated as described above, the scan information 203 can be edited. Further, the attribute data of the scanning device 102 includes the attribute information indicating the functions which can be designated in the scanning device 102 (capabilities of the scanning device 102) and settings associated with the attribute information, and these are stored in the RAM 113.

With this configuration, the general-purpose scan software 202 enables a user to designate a scan function which can be used in the scanning device 102 according to the scanning device 102 connected to the host computer 101. With this, regardless of the scanning device 102, i.e. even in a case where the scanning device 102 having a different function or the scanning device 102 developed by a different scanner maker is connected, it is possible to designate a scan function which can be used in the connected scanning device 102. Note that in the present embodiment, the general-purpose scan software 202 is a standard class driver that executes scanning based on a standard scan protocol called Mopria (registered trademark). Specifically, the general-purpose scan software 202 is not a scan driver specific to a model of the scanning device 102 but is a standard class driver which can be commonly used for scanning devices 102 of scanner makers, irrespective of a specific scanner maker. Further, the general-purpose scan software 202 acquires the capabilities information of the scanning device 102 and generates the scan function information 203 based on the acquired information.

Further, the general-purpose scan software 202 can be associated with the extension application 204. This enables the general-purpose scan software 202 to execute a function which is not supported by the general-purpose scan software 202. For example, in a case where the scanning device 102 is caused to execute the scan function, the general-purpose scan software 202 cannot receive an adjustment setting for adjusting at least one of saturation and hue for an image to be scanned, i.e. a target image of execution of a scan function (scan image). That is, the general-purpose scan software 202 does not support the adjustment setting. This is because the adjustment setting is a function uniquely executed by the scanning device 102 manufactured by a predetermined scanner maker.

Hereinafter, the adjustment setting for adjusting at least one of saturation and hue is referred to as saturation/hue adjustment setting (saturation/hue adjustment function). The extension application 204 can extend functions of the general-purpose scan software 202 such that functions which cannot be caused to be executed by the general-purpose scan software 202 can be caused to be executed. Although in the present embodiment, the general-purpose scan software 202 cannot perform the saturation/hue adjustment setting, but the extension application 204 can extend the function such that the general-purpose scan software 202 can be executed, this is not limitative. For example, the general-purpose scan software 202 can execute part of the saturation/hue adjustment setting, and the extension application 204 can further extend the execution range by compensating for the shortage of the saturation/hue adjustment setting.

The saturation/hue adjustment setting is capable of adjusting the vividness and color shade of a scanned image. The saturation adjustment is a function of adjusting vividness, and is capable of making the scanned image vivid or making the same less vivid on purpose to give a calm impression. The hue adjustment is a function of adjusting a color shade, and is capable of performing changing of the color shade, including changing of a blue color included in a scanned image into a light blue color and changing of a yellow green color into a green color. The saturation adjustment and the hue adjustment are performed independent of each other, or in combination. Now, a description will be given of an example of the saturation/hue adjustment setting. In the description, it is assumed that colors included in a scanned image are red (R), green (G), and blue (B), which are generally used, and the data of the colors assume eight bits of 0 to 255, but this is not limitative. In this description, calculations are performed for the saturation adjustment and the hue adjustment, simultaneously, by way of example. Further, for saturation, the intensity of vividness is designated, and for hue, a color shade after the adjustment, such a yellow or a red, is designated. In the saturation/hue adjustment setting, first, a transformation matrix is acquired based on settings of the saturation/hue adjustment designated by a user operation. In the present embodiment, a matrix shown in the following equation (1) defined in advance in association with settings is acquired.

$$[ \begin{matrix}a 11 & a 12 & a 13 & a 14 & a 15 & a 16 \\ a 21 & a 22 & a 23 & a 24 & a 25 & a 26 \\ a 31 & a 32 & a 33 & a 34 & a 35 & a 36\end{matrix} ] \qquad ( 1 )$$

Further, input RGB signal values are decomposed into the six colors of c, m, y, r, g, and b, by using the following equations (2) to (4).

$$Krgb = min ( R , G , B ) \qquad ( 2 )$$

$$[ \begin{matrix}c \\ m \\ y\end{matrix} ] = [ \begin{matrix}min ( G - Krgb , B - Krgb ) \\ min ( B - Krgb , R - Krgb ) \\ min ( R - Krgb , G - Krgb )\end{matrix} ] \qquad ( 3 )$$

$$[ \begin{matrix}r \\ g \\ b\end{matrix} ] = [ \begin{matrix}R - Krgb - max ( m , y ) \\ G - Krgb - max ( y , c ) \\ B - Krgb - max ( c , m )\end{matrix} ] \qquad ( 4 )$$

Next, corrections amounts ΔR, ΔG, and ΔB of R, G, and B are calculated by using the following equation (5).

$$[ \begin{matrix}Δ R \\ Δ G \\ Δ B\end{matrix} ] = [ \begin{matrix}a 11 & a 12 & a 13 & a 14 & a 15 & a 16 \\ a 21 & a 22 & a 23 & a 24 & a 25 & a 26 \\ a 31 & a 32 & a 33 & a 34 & a 35 & a 36\end{matrix} ] \neq [ \begin{matrix}r \\ g \\ b \\ y \\ c \\ m\end{matrix} ] \qquad ( 5 )$$

Next, RGB values R′, G′, and B′ after the saturation/hue adjustment are calculated by using the following equation (6).

$$[ \begin{matrix}{R}^{′} \\ {G}^{′} \\ {B}^{′}\end{matrix} ] = [ \begin{matrix}R \\ G \\ B\end{matrix} ] + [ \begin{matrix}Δ R \\ Δ G \\ Δ B\end{matrix} ] \qquad ( 6 )$$

As for execution of scan, a variety of image processing including color conversion are performed so as to make better the impression of appearance of a scanned image. Further, the preference of the appearance of colors of a scanned image varies with a person. Particularly, for images including photograph images and graphics, office document images in which pictures of presentation materials or the like and objects such as graphs are arranged, and the like, preferable colors change depending on a state of recognition at the time or the like. Therefore, it is preferrable to not only perform image processing but also adjust colors according to a user's preference. In the present embodiment, it is possible to reproduce user's favorite colors by the saturation/hue adjustment.

The configuration in the case where the extension application 204 is associated with the general-purpose scan software 202 and the scanning device 102 will be described with reference to FIG. 2B. As shown in FIG. 2B, differently from FIG. 2A, the extension application 204 is added in this configuration. That is, the host computer 101 includes the scan application 201, the general-purpose scan software 202, and the scan function information 203, and further has the extension application 204. The extension application 204 is software for extending the function of the general-purpose scan software 202 and is sometimes simply referred to as the scan software. Note that the extension application 204 is software which is not included (packaged) in the OS in advance. Therefore, the extension application 204 is downloaded from a server (not shown) via the Internet and installed into the host computer 101 according to a user's operation of the host computer 101. Alternatively, when the scanning device 102 is connected to the host computer 101, the extension application 204 can be automatically installed into the host computer 101 according to this connection. Specifically, when the scanning device 102 is connected to the host computer 101, the OS acquires device identification information from the scanning device 102. The OS can download the extension application 204 associated with this device identification information from the server via the Internet and install the downloaded extension application 204. As a result, in the host computer 101, the general-purpose scan software 202 and the extension application 204 are held as control programs independent of each other. Note that the general-purpose scan software 202 and the extension application 204 are sometimes updated and their versions are upgraded, respectively. The processing for updating the general-purpose scan software 202 and the processing for updating the extension application 204 in this case can be executed at the same timing or at different timings. Further, a trigger with which the general-purpose scan software 202 is acquired by the host computer 101 and a trigger with which the extension application 204 is acquired by the host computer 101 can be the same trigger or different triggers. Further, in a case where the extension application 204 has been installed, the OS associates the extension application 204 with the general-purpose scan software 202 and the scanning device 102.

As shown in FIG. 2B, the extension application 204 is capable of exchanging information (transmission and reception of information) with the general-purpose scan software 202 and the scanning device 102, respectively. That is, the extension application 204 is associated with the general-purpose scan software 202 and the scanning device 102. In the present embodiment, the extension application 204 includes a scan setting screen-extending unit 205, a scan function-extending unit 206, an image data-editing unit 207, and a notification unit 209. Further, the extension application 204 includes shared information 208 which can be accessed from each of the scan setting screen-extending unit 205, the scan function-extending unit 206, the image data-editing unit 207, and the notification unit 209. The shared information 208 is a file stored in the external storage device 114 or information stored in the RAM 113. The extension application 204 can write and read the shared information 208 by using an application program interface (API) provided by the OS.

Note that the extension application 204 can terminate the operation as a whole of the extension application 204 in accordance with termination of processing executed by each unit of the scan setting screen-extending unit 205 to the notification unit 209. In this case, the OS starts the extension application 204 whenever a request for causing each unit to execute processing is received. Further, during execution of processing by each unit of the scan setting screen-extending unit 205 to the notification unit 209, the extension application 204 can cancel the processing. In this case, a job being processed on a print queue is deleted by the OS. As described above, upon receipt of a print request from a user, the scan application 201 issues a scan instruction to the OS. Further, the scan application 201 can display the scan setting screen. In the configuration shown in FIG. 2B, the scan application 201 can display the scan setting screen 300A (detailed setting screen 300C) provided by the scan setting screen-extending unit 205 (the extension application 204). Further, the scan setting screen-extending unit 205 can store detailed settings made by the user in the shared information 208.

The image data-editing unit 207 acquires image data from the scanning device 102. Then, after acquisition of the image data, the image data-editing unit 207 can also edit the acquired image data. Further, the image data-editing unit 207 acquires detailed setting information from the shared information 208 and performs image editing on the image data according to the detailed setting information. The extension application 204 can also perform image editing on image data acquired by the general-purpose scan software 202 according to the detailed setting information. Further, also in the case of the configuration shown in FIG. 2B, there is a case where the saturation/hue adjustment setting is not executed. In this case, the general-purpose scan software 202 can transmit a scan request instruction to the scanning device 102 without using the extension application 204.

The scan function-extending unit 206 can edit the scan function information 203 generated by the general-purpose scan software 202 or the OS. This makes it possible to add a function provided by the extension application 204. Further, it is also possible to add a function which can be executed in the scanning device 102 but cannot be executed by the general-purpose scan software 202 (such as the saturation/hue adjustment function), and add an exclusive relationship between settings of the scan function, and so forth. The OS starts the scan function-extending unit 206 when the extension application 204 is associated with the scanning device 102 and the general-purpose scan software 202 for the first time. Further, the OS can start the scan function-extending unit 206 at a timing other than this (e.g. at a timing when the OS is started). By starting the scan function-extending unit 206 as described above, the scan function-extending unit 206 can detect the extended function and add the detected function to the scan function information 203, even in a case where a function related to scanning is extended later.

The notification unit 209 can provide, when an error of the scanning device 102 occurs, a notification indicating this fact. For example, if a reading jam error has occurred in the scanning device 102, the general-purpose scan software 202 detects occurrence of this error. The OS displays a message showing occurrence of the reading jam error as a result of the detection performed by the general-purpose scan software 202 on the display section 119 by using a notification function referred to as the toast notification which is one of the functions of the OS. Note that when the user operates the toast notification, the notification unit 209 is called by the OS, and a user interface screen (UI screen) of the notification unit 209 is displayed. On the user interface screen, for example, a detailed message concerning the reading jam error, a jam resolving method, and so forth can be displayed.

As described above, in the present embodiment, it can be said that the extension application 204 has the following four functions: The first function is the function of displaying a setting screen. This function is executed by the scan setting screen-extending unit 205. The second function is the function of editing image data according to the detailed setting information. This function is executed by the image data-editing unit 207. The third function is the function of extending a function which can be designated, by using image data generation software. This function is executed by the scan function-extending unit 206. The fourth function is the function of displaying a screen in response to occurrence of an error in the scanning device 102. This function is executed by the notification unit 209. Note that the configuration of the extension application 204 is not limited to the configuration having these four functions but is preferable to have at least one function of them, and further, the extension application 204 can be configured to further have another function.

FIGS. 3A to 3D are diagrams each showing an example of a screen displayed on the display section 119 of the scan system 1000. FIG. 3A shows the scan setting screen displayed by the scan application 201. FIG. 3B shows the detailed setting screen displayed in the case of the configuration in which the extension application 204 is not associated. FIG. 3C shows the detailed setting screen displayed in the case of the configuration in which the extension application 204 is associated. FIG. 3D is a variation of the detailed setting screen displayed in the case of the configuration in which the extension application 204 is associated. Note that a unit or module that displays each screen is not particularly limited. For example, the scan setting screen-extending unit 205 is only required to be configured to be capable of generating a display screen. In this case, the scan setting screen-extending unit 205 transmits the generated display screen to the scan application 201 via the general-purpose scan software 202. The scan application 201 can be configured to display the acquired display screen.

The scan setting screen 300A shown in FIG. 3A is a screen on which the setting associated with scanning performed by the scanning device 102 can be set. This scan setting screen 300A includes a control (button) 301, the control 302, a control 303, and a control 304. With the control 301, the user can select and set a scanner device used for reading an original. In the illustrated example in FIG. 3A, the scanner device used for reading an original is set to scanner 001 (common driver) by way of example. With the control 302, the user can make detailed settings of the saturation/hue adjustment. With the control 303, the user can instruct the scanning device 102 to start scanning. With the control 304, the user can instruct the scanning device 102 to cancel scanning.

When the control 302 is operated in the case of the configuration in which the extension application 204 is not associated, the detailed setting screen 300B shown in FIG. 3B is displayed. The detailed setting screen 300B includes a control 305 and a control 306. With the control 305, the user can select and set a scanning location of an original in the scanning device 102, i.e. a placement section where an original to be read is placed. For example, in a case where the scanning device 102 has a scanner bed (original platen glass) and a feeder, as original scanning locations, the canner bed is selected, as illustrated in FIG. 3B, by way of example. With the control 306, the user can terminate the setting on the control 305. Further, when the control 306 is operated, the screen returns to the scan setting screen 300A shown in FIG. 3A.

When the control 302 is operated in the case of the configuration in which the extension application 204 is associated, the detailed setting screen (setting reception screen) 300C shown in FIG. 3C is displayed (display control step) Note that the detailed setting screen 300C is a screen displayed together with the scan setting screen 300A, but its display form is not particularly limited. For example, the detailed setting screen 300C can be displayed in a state overlapping the scan setting screen 300A. Further, the detailed setting screen 300C can be displayed adjacent to the scan setting screen 300A or cab be displayed after the scan setting screen 300A once disappears. The detailed setting screen 300C is a screen having a function of receiving settings of saturation and hue of an image generated by the scan function of the scanned image 102 (hereinafter referred to as the saturation/hue adjustment setting). Similar to the detailed setting screen 300B, the detailed setting screen 300C includes the control 305 and the control 306.

Further, the detailed setting screen 300C additionally includes a saturation adjustment slide bar 307, a hue adjustment slide bar 308. The saturation adjustment slide bar 307 is a saturation adjustment portion capable of setting a saturation adjustment amount for adjusting saturation. The hue adjustment slide bar 308 is a hue adjustment portion capable of adjusting a hue adjustment amount for adjusting hue. The hue adjustment slide bar 308 is capable of setting the hue to a purple side as the hue adjustment slide bar 308 is slid leftward, and capable of setting the hue to a red side as the hue adjustment slide bar 308 is slid rightward. In the detailed setting screen 300C, it is possible to perform adjustment by both of the saturation adjustment slide bar 307 and the hue adjustment slide bar 308. Besides, in the detailed setting screen 300C, adjustment by one of the saturation adjustment slide bar 307 and the hue adjustment slide bar 308 can be performed while omitting adjustment by the other. In FIG. 3C, the saturation adjustment slide bar 307 is set to “+1” as an example of saturation. Further, as an example of hue, the hue adjustment slide bar 308 is set to “0 (no adjustment)”. Then, by operating the control 306, a setting made by the saturation adjustment slide bar 307 and a setting made by the hue adjustment slide bar 308 can be finalized. In the case of FIG. 3C, execution of scan based on the setting of “+1” for saturation by the saturation adjustment slide bar 307 and the setting of “0 (no adjustment)” for hue by the hue adjustment slide bar 308 is instructed to the scanning device 102 (instruction step). The scanning device 102 is capable of executing the scan function according to the instruction. With the detailed setting screen 300C, it is possible to adjust (set) the saturation and hue on an image generated by the scan function. Note that in the present embodiment, the detailed setting screen 300C is configured such that it is possible to adjust the saturation and hue, but this is not limitative, and for example, the detailed setting screen 300C can be configured such that it is possible to adjust at least one of the saturation and hue, and can be a screen in which the other adjustment is omitted.

Further, in the detailed setting screen 300C, in place of the saturation adjustment slide bar 307 and the hue adjustment slide bar 308, the saturation/hue adjustment display 316 and the preview image 319 shown in FIG. 3D can be included. The saturation/hue adjustment display 316 is configured such that desired saturation and hue can be set by moving a pointer 317 about the center of saturation/hue adjustment display 316 as an origin. At the origin, it is regarded that no settings have been made for the saturation and the hue. Further, according to a distance from the origin, saturation is adjusted to set an adjustment amount thereof. Also, according to an angle (rotational angle) of rotation about the origin, hue is adjusted to set an adjustment amount thereof. For example, when the pointer 317 is moved to a position 318, the saturation can be set to “+1” and the hue can be set to “+2” in a yellow direction. The preview image 319 is an image subjected to the saturation/hue adjustment setting. This makes it possible to grasp a state of the image subjected to the saturation/hue adjustment setting. Note that the preview image 319 is not particularly limited, and, for example, besides the image subjected to the saturation/hue adjustment setting, further, an image before the saturation/hue adjustment setting can be included. In this case, it is possible to compare the image before the saturation/hue adjustment setting and the image subjected to the saturation/hue adjustment setting.

Here, a reason why the items included in the detailed setting screen 300B shown in FIG. 3B and the items included in the detailed setting screen 300C shown in FIG. 3C are different will be described. That is, a reason why it is possible to switch whether to display the detailed setting screen 300B or the detailed setting screen 300C will be described. The detailed setting screen 300B and the detailed setting screen 300C are generated based on respective pieces of the scan function information (capabilities information). As described above, the general-purpose scan software 202 does not support the saturation/hue adjustment setting. Therefore, the saturation/hue adjustment setting function cannot be added to the scan function information only by the general-purpose scan software 202. Further, even if the saturation/hue adjustment setting function is originally included in the scan function information, the general-purpose scan software 202 cannot interpret the saturation/hue adjustment setting function included in the scan function information. For this reason, the saturation/hue adjustment setting cannot be displayed on the detailed setting screen. To cope with this, the scan function-extending unit 206 adds the saturation/hue adjustment setting function to the scan function information 203. Then, the scan setting screen-extending unit 205 displays the detailed setting screen 300C by referring to the capabilities information. This detailed setting screen 300C is a screen on which the saturation/hue adjustment setting can be made. Note that the detailed setting screen 300C can additionally include a setting item other than the saturation/hue adjustment setting.

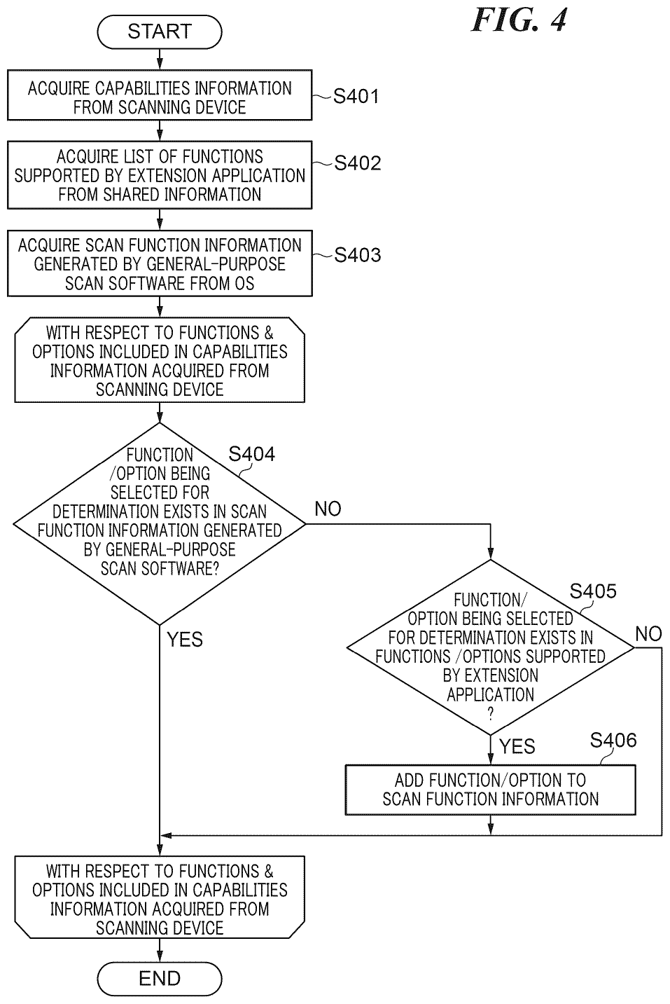

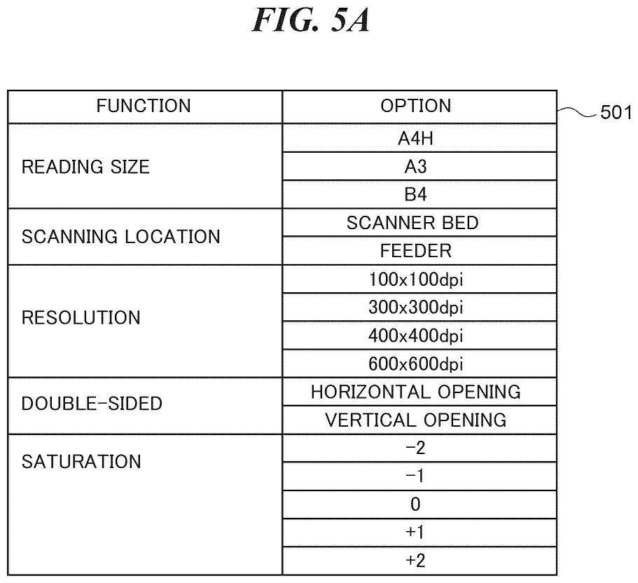

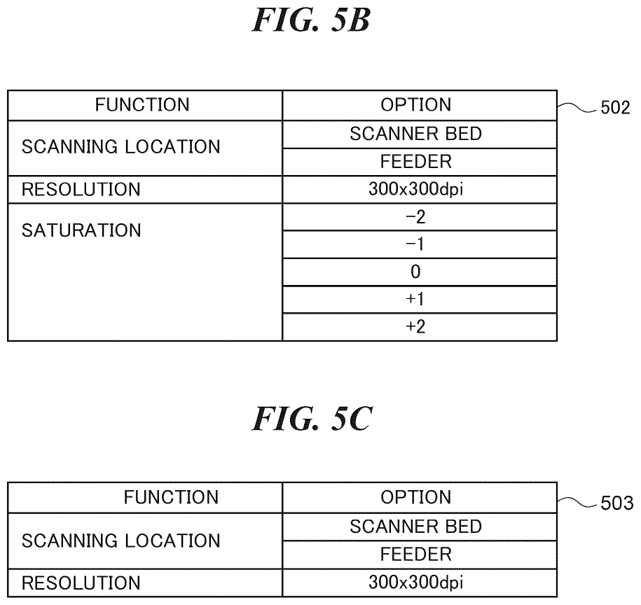

FIG. 4 is a flowchart of a process performed by the scan function-extending unit 206, for editing the scan function information. Note that a program for the process in FIG. 4 is executed by the scan function-extending unit 206 under the control of the CPU 111. FIGS. 5A to 5C are diagrams each showing an example of a list of the scan information. Referring to FIG. 4, in a step S401, the scan function-extending unit 206 acquires the capabilities information from the scanning device 102 (acquisition step). This acquisition step is performed before the above-described display control step. The capabilities information is information concerning the capability of executing the scan function, and in the present embodiment, attribute information indicating the functions which can be designated in the scanning device 102 and settings associated with this attribute information. A table 501 shown in FIG. 5A indicates a list of the capabilities information acquired from the scanning device 102. As shown in the table 501, the functions of the saturation adjustment and the like, and options which can be set to each function can be acquired from the scanning device 102. For example, functions of the saturation adjustment has options of “+2” to “−2”. Thus, for the range in which the saturation adjustment can be set, an upper limit and a lower limit are provided. Note that although functions are not displayed in the table 501, the hue adjustment function is included.

In a step S402, the scan function-extending unit 206 acquires scan functions supported by the extension application 204 from the shared information 208. In the shared information 208, a list of the scan functions supported by the extension application 204 is stored. A table 502 shown in FIG. 5B includes all scan functions which can be executed (supported) by the extension application 204 and the settings of these scan functions. For example, the saturation adjustment function has options of “−2” to “+2”. Thus, a range in which the saturation adjustment can be set has an upper limit and a lower limit set thereto. Note that, similar to the table 501, the table 502 includes a hue adjustment function, though not illustrated therein. Further, the scan functions which can be executed by the extension application 204 are sometimes updated e.g. by the update of the extension application 204.

In a step S403, the scan function-extending unit 206 acquires the scan function information 203 generated by the general-purpose scan software 202 from the OS. The scan function information 203 is generated by the general-purpose scan software 202 based on the capabilities information acquired from the scanning device 102. The scan function information 203 generated by the general-purpose scan software 202 includes only the scan functions which can be executed by the general-purpose scan software 202, out of the capabilities information acquired from the scanning device 102. A table 503 shown in FIG. 5C includes all scan functions which can be executed by the general-purpose scan software 202 and the settings of these scan functions. As shown in the table 503, the scan functions which can be executed by the general-purpose scan software 202 do not include the function of the saturation/hue adjustment setting.

Therefore, the saturation/hue adjustment setting is not included in the scan function information 203. By adding a function and options thereof to the scan function information 203 by using the scan function-extending unit 206, the extension application 204 can compensate for lack of the functions of the general-purpose scan software 202. Further, the scan function-extending unit 206 is also capable of deleting an unnecessary function and options thereof from the scan function information 203 generated by the general-purpose scan software 202. A step S404, a step S405, and a step S406 are processing operations which are repeatedly executed on the list of the functions included in the capabilities information acquired from the scanning device 102 in the step S401. In the present embodiment, the steps S404, S405, and S406 are repeatedly executed on all of the 16 options included in the table 501.

In the step S404, the scan function-extending unit 206 determines whether or not a function and its option, being currently selected for determination, exist in the scan function information 203 generated by the general-purpose scan software 202. If it is determined in the step S404 that the function and its option, being currently selected for determination, exist in the scan function information 203, the present process is terminated if the option being selected for determination is the final item of the options of the function. Alternatively, if the option being selected for determination is not the final item of the options of the function, the next item of the options is selected, and the step S404 is executed again. On the other hand, if it is determined in the step S404 that the function and its option, being currently selected for determination, do not exist in the scan function information 203, the process proceeds to the step S405. For example, in the present embodiment, the scanning location “scanner bed” is included in the table 501, and the scanning location “scanner bed” is also included in the table 503. In this case, it is determined in the step S404 that the function and its option, being currently selected for determination, exist in the scan function information 203. On the other hand, “−2” is included in the table 501 but “−2” is not included in the table 503. In this case, it is determined in the step S404 that the function and its option, being currently selected for determination, do not exist in the scan function information 203.

In the step S405, the scan function-extending unit 206 determines whether or not the function (option), being currently selected for determination, exists in the functions (options) supported by the extension application 204. If it is determined in the step S405 that the function being currently selected for determination exists, the process proceeds to the step S406. On the other hand, if it is determined in the step S405 that the function being currently selected for determination does not exist, similar to the case where the answer to the question of the step S404 is affirmative (YES), the present process is terminated if the option being selected for determination is the final item of the options of the function. Alternatively, if the option being selected for determination is not the final item of the options of the function, the next item of the options is selected, and the step S404 is executed again. For example, in the present embodiment, in a case where the option of the function being currently selected for determination is “−2”, the option “−2” also exists in the table 502. Therefore, it is determined in the step S405 that the function being currently selected for determination exists.

In the step S406, the scan function-extending unit 206 adds the function (option) being currently selected for determination, to the scan function information 203. After execution of the step S406, similar to the case where the answer to the question of the step S404 is affirmative (YES), the present process is terminated if the option being selected for determination is the final item of the options of the function. Alternatively, if the option being selected for determination is not the final item of the options of the function, the next item of the options is selected, and the step S404 is executed again.

As described above, the extension application 204 can add, to the scan function information 203, a function (option) which is not supported by the general-purpose scan software 202 but is supported by the scanning device 102, and at the same time can be supported by the extension application 204. Then, the capabilities information is generated based on the scan function information 203 edited by this addition processing. Further, by generating a display screen based on the resulting capabilities information, the scan setting screen-extending unit 205 can extend the function not supported by the general-purpose scan software 202 and display the detailed setting screen 300C shown in FIG. 3C.

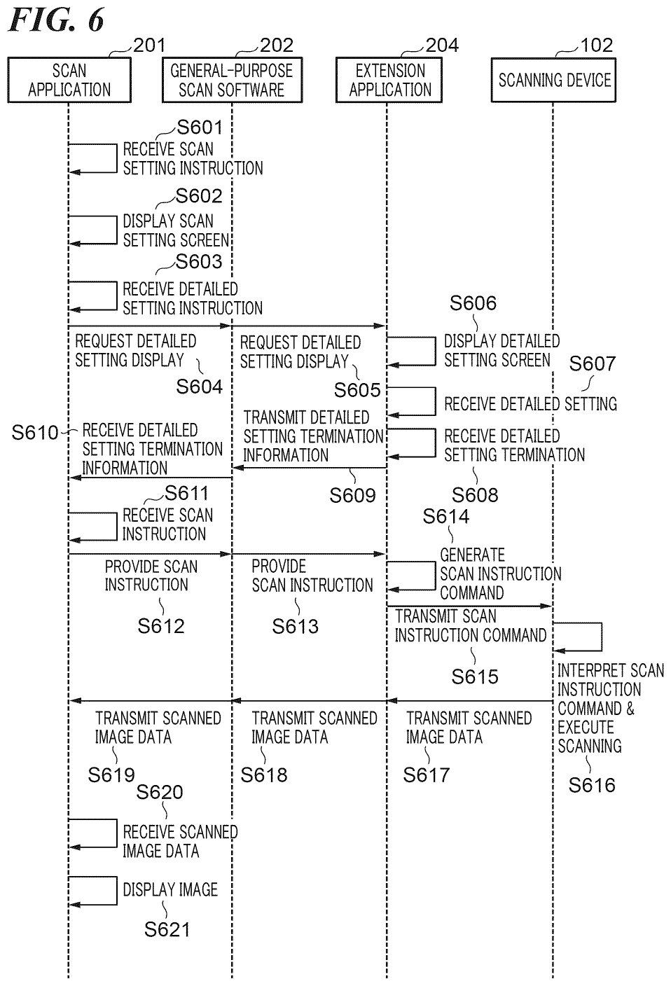

FIG. 6 is a sequence diagram showing a process executed between the scan application 201, the general-purpose scan software 202, the extension application 204, and the scanning device 102, after the scan application 201 receives a scan setting instruction. Processing operations performed by the scan application 201, the general-purpose scan software 202, and the extension application 204 are executed by the CPU 111 of the host computer 101. A processing program for the operations is stored in the external storage device 114. The CPU 111 loads the processing program from the external storage device 114 into the RAM 113 and executes the loaded processing program. Further, processing operations performed by the scanning device 102 are executed by the CPU 191 of the scanning device 102. A processing program for the operations is stored in the external storage device 199. The CPU 191 loads the processing program from the external storage device 199 into the RAM 193 and executes the loaded processing program. Further, the software configuration of the scan system 1000 is shown in FIG. 2B.

Referring to FIG. 6, in a step S601, the scan application 201 receives the scan setting instruction by a user. The user can instruct the scan setting to the scan application 201 by operating e.g. the pointing device 117 and the keyboard 118.

In a step S602, the scan application 201 displays the scan setting screen 300A shown in FIG. 3A on the display section 119.

In a step S603, the scan application 201 receives a detailed setting instruction provided by the user. The user can instruct the detailed setting by operating e.g. the pointing device 117 and the keyboard 118 to select the control 302 on the scan setting screen 300A.

In a step S604, the scan application 201 requests the general-purpose scan software 202 to display the detailed setting.

In a step S605, the general-purpose scan software 202 requests the extension application 204 to display the detailed setting.

In a step S606, the scan setting screen-extending unit 205 of the extension application 204 displays the detailed setting screen 300C illustrated in FIG. 3C on the display section 119 in response to the request received in the step S605. As described hereinabove, the saturation/hue adjustment setting is added to the scan function information 203 by the scan function-extending unit 206. The scan setting screen-extending unit 205 can display the detailed setting screen 300C by referring to the capabilities information generated based on the scan function information 203 to which the saturation/hue adjustment setting has been added. Note that in a case where a setting item of resolution of an image and the like are included, these setting items can be displayed as required, or can be inhibited from being displayed or be displayed in a grayed-out state.

In a step S607, the scan setting screen-extending unit 205 receives the detailed setting input by the user on the detailed setting screen 300C. Here, let it be assumed that on the detailed setting screen 300C, the scanning location “the scanner bed” is selected by the control 305, a saturation of “+1” is set by the saturation adjustment slide bar 307, and a hue of “0 (no adjustment)” is set by the hue adjustment slide bar 308 (see FIG. 3C). In this setting state, the scan setting screen-extending unit 205 receives the operation of the control 306 on the detailed setting screen 300C, which is performed by the user. With this, the CPU 111 stores the setting state on the detailed setting screen 300C in the RAM 113.

In a step S608, the scan setting screen-extending unit 205 receives termination of the detailed setting performed by the user based on the operation of the control 306 in the step S607. The user can instruct termination of the detailed setting by operating e.g. the pointing device 117 or the keyboard 118 to select the control 306. With this, the setting state on the detailed setting screen 300C is written into the scan function information 203. Note that the information written into the scan function information 203 can also include, for example, the information inhibited from being displayed or displayed in the grayed-out state.

In a step S609, the extension application 204 transmits detailed setting termination information to the effect that the detailed setting in the S608 has been terminated, to the general-purpose scan software 202.

In a step S610, the general-purpose scan software 202 receives the detailed setting termination information sent from the extension application 204 in the step S609. Then, the general-purpose scan software 202 transmits this detailed setting termination information to the scan application 201.

In a step S611, the scan application 201 receives a scan instruction provided by the user. The user can instruct scanning by operating e.g. the pointing device 117 or the keyboard 118 to select the control 303 on the scan setting screen 300A (see FIG. 3A).

In a step S612, the scan application 201 provides the scan instruction received in the step S611 to the general-purpose scan software 202.

In a step S613, the general-purpose scan software 202 receives the scan instruction provided in the step S612. Then, the general-purpose scan software 202 provides this scan instruction to the extension application 204.

In a step S614, the extension application 204 receives the scan instruction provided in the step S613. Then, the extension application 204 generates a scan instruction command based on the scan function information 203 in which the setting state on the detailed setting screen 300C has been written in the step S608. Note that this scan instruction command includes the setting information of the saturation/hue adjustment received on the detailed setting screen 300C. Further, there is a case where the information inhibited from being displayed or displayed in the grayed-out state in the step S608 has not been written into the scan function information 203. In this case, in the step S614, the extension application 204 can add the information which has not been written into the scan function information 203 to the scan instruction command or can be set as the default value.

In a step S615, the extension application 204 transmits the scan instruction command generated in the step S614 to the scanning device 102.

In a step S616, the input/output interface 198 of the scanning device 102 receives the scan instruction command transmitted in the step S615. Then, the reading section 195 of the scanning device 102 interprets the scan instruction command and executes scanning under the conditions set on the detailed setting screen 300C. As a result, as the scanned image data (read image data), image data subjected to the saturation/hue adjustment is obtained. An image subjected to the saturation/hue adjustment is an image emphasized in vividness compared with a case where the image is not subjected to the saturation/hue adjustment. More specifically, out of the aforementioned values in three rows and six columns for the saturation/hue adjustment, which are stored in the ROM 192 and are associated with values of the saturation setting in advance, values in three rows and six columns associated with a saturation of “+1” are extracted, and calculations of the above-described saturation/hue adjustment are executed for pixel values of image data acquired by scan. In a case where a saturation of “−2” is set, image data suppressed in vividness is generated. The generation processing is the same as performed for saturation, and values in three rows and six columns associated with a saturation of “−2” are extracted from the ROM 192 to thereby adjust the settings of the scan image data. Note that in the present embodiment, although the description is given of values in the three rows and six columns for the saturation/hue adjustment are stored in the ROM 192 in advance on a setting-by-setting basis, this is not limitative. For example, by storing in advance only values as a reference in the three rows and six columns in the ROM 192, values in the three rows and six columns can be calculated by performing calculation on the three rows and six columns.

In a step S617, the input/output interface 198 of the scanning device 102 transmits the scanned image data obtained in the step S616 to the extension application 204.

In a step 618, the extension application 204 receives the scanned image data transmitted in the step S617 (acquisition step). Then, the extension application 204 transmits this scanned image data to the general-purpose scan software 202.

In a step S619, the general-purpose scan software 202 receives the scanned image data sent in the step S618. Then, the general-purpose scan software 202 transmits this scanned image data to the scan application 201.

In a step S620, the scan application 201 receives the scanned image data sent in the step S619.

In a step S621, the scan application 201 displays the scanned image data received in the step S620 on the display section 119. As a result, the scanned image data, i.e. the image data subjected to the saturation/hue adjustment is displayed on the display section 119 as a preview image.

As described above, in the scan system 1000, even in a case where the general-purpose scan software 202 does not support the saturation/hue adjustment setting, it is possible to execute the saturation/hue adjustment setting by using the extension application 204. This enables the scanning device 102 to perform scanning under the saturation/hue adjustment setting, and as a result, the scanned image becomes an image of which the saturation and the hue has been adjusted. Note that in the description given with reference to FIG. 6, assuming that the software configuration of the scan system 1000 is as shown in FIG. 2B, the detailed setting screen 300C shown in FIG. 3C is displayed, but this is not limitative. For example, in a case where a request for displaying the detailed setting is provided to the general-purpose scan software 202 in the step S604, the general-purpose scan software 202 displays the detailed setting screen 300B shown in FIG. 3B. In this case, after the control 306 on the detailed setting screen 300B is operated, the general-purpose scan software 202 requests the extension application 204 to display an additional detailed setting screen. Then, the extension application 204 can additionally display a detailed setting screen on which the saturation/hue adjustment setting can be performed.

Further, in the step S613, the scan instruction is provided from the general-purpose scan software 202 to the extension application 204, but this is not limitative. For example, the scan instruction can be provided from the scan application 201 to the extension application 204. Further, a control for a scan instruction can be disposed on the detailed setting screen 300C. In this case, when the user operates the control for a scan instruction, a scan instruction is provided to the extension application 204. Further, the scanned image data can be transmitted from the scanning device 102 to the scan application 201 via the extension application 204 without via the general-purpose scan software 202. Further, the scanned image data can be transmitted from the scanning device 102 directly to the scan application 201. Further, the scan system 1000 can be configured such that the scanned image data is stored in the external storage device 114, and only information of a file path as storage destination can be sent and received. Further, in the scan system 1000, in a case where there are a plurality of scanned image data, all the scanned image data can be collectively transmitted, or each scanned image data can be transmitted whenever the scanned image data is obtained.

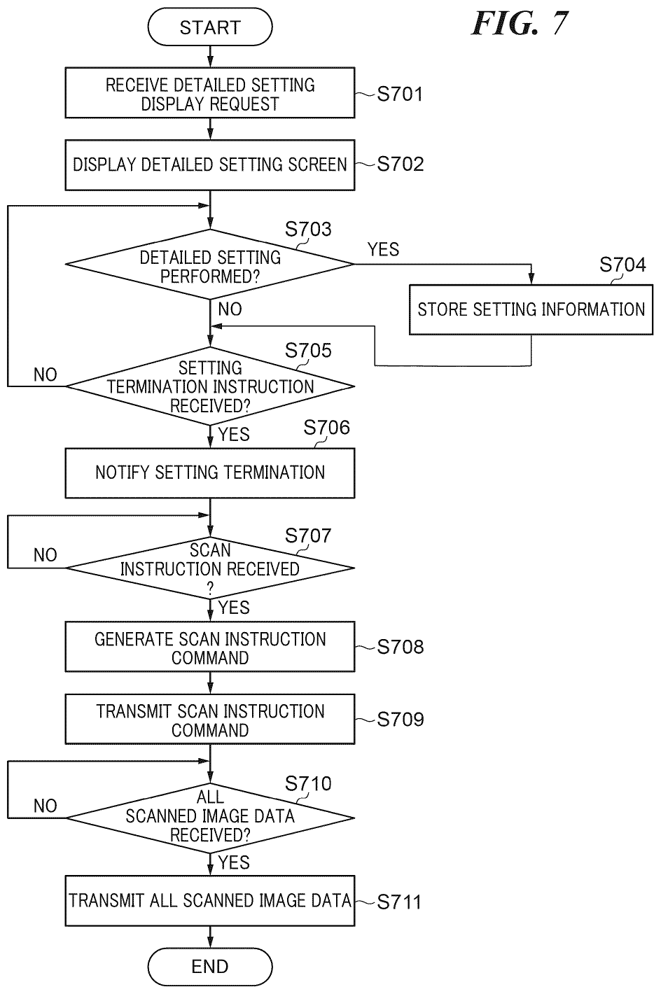

FIG. 7 is a flowchart of the process performed by the extension application 204. A program for executing the process in FIG. 7 is stored in the external storage device 114. The CPU 111 can execute the present process by loading the program from the external storage device 114 into the RAM 113. Referring to FIG. 7, in a step S701, the extension application 204 receives the request for displaying the detailed setting (see the step S605) from the general-purpose scan software 202.

In a step S702, the scan setting screen-extending unit 205 of the extension application 204 displays the detailed setting screen 300C shown in FIG. 3C on the display section 119 in response to the detailed setting display request received in the step S701. As described hereinabove, the saturation/hue adjustment setting is added to the scan function information 203. The scan setting screen-extending unit 205 can display the detailed setting screen 300C by referring to the capabilities information generated based on the scan function information 203.

In a step S703, the scan setting screen-extending unit 205 determines whether or not the detailed setting has been performed on the detailed setting screen 300C, i.e. whether or not a selection operation has been performed on the control 305, the saturation adjustment slide bar 307, and the hue adjustment slide bar 308. If it is determined in the step S703 that the detailed setting has been performed, the process proceeds to a step S704. On the other hand, if it is determined in the step S703 that the detailed setting has not been performed, the process proceeds to a step S705.

In the step S704, the scan setting screen-extending unit 205 stores (saves) the setting state (setting information) on the detailed setting screen 300C in the RAM 113. After execution of the step S704, the process proceeds to the step S705.

In the step S705, the scan setting screen-extending unit 205 determines whether or not a detailed setting termination instruction has been provided on the detailed setting screen 300C, i.e. whether or not the control 306 has been operated. If it is determined in the step S705 that a detailed setting termination instruction has been provided, the process proceeds to a step S706. On the other hand, if it is determined in the step S705 that the detailed setting termination instruction has not been provided, the process returns to the step S703 to sequentially execute the step S703 et seq.

In the step S706, the extension application 204 notifies the general-purpose scan software 202 of the detailed setting termination instruction provided in the step S705.

In a step S707, the extension application 204 determines whether or not a scan instruction has been provided from the general-purpose scan software 202 (see the step S613). If it is determined in the step S707 that the scan instruction has been provided, the process proceeds to a step S708. On the other hand, if it is determined in the step S707 that the scan instruction has not been provided, the process remains in the step S707.

In the step S708, the extension application 204 generates a scan instruction command based on the scan function information 203 in which the setting state on the detailed setting screen 300C has been written. Further, as the method of generating a scan instruction command, for example, a method of extending a standard protocol command can be used. Further, as this extension method, for example, a method of describing a dedicated command in an extended area of the standard protocol command can be used. The other extension methods include a method of adding an original standard command to the end of the standard protocol command, a method of overwriting the standard protocol command with an original command system the extension application 204, and the like. Further, in a case where an instruction is provided from the extension application 204, instruction and communication can be performed according to a protocol unique to a maker, irrespective of the standard protocol.

In a step S709, the extension application 204 transmits the scan instruction command generated in the step S708 to the scanning device 102.

In a step S710, the extension application 204 determines whether or not all of the scanned image data have been received from the scanning device 102 (see the step S617). If it is determined in the step S710 that all of the scanned image data have been received, the process proceeds to a step S711. On the other hand, if it is determined in the step S710 that all of the scanned image data have not been received, the process remains in the step S710.

In the step S711, the extension application 204 transmits all the scanned image data received from the scanning device 102 to the general-purpose scan software 202, followed by terminating the present process.

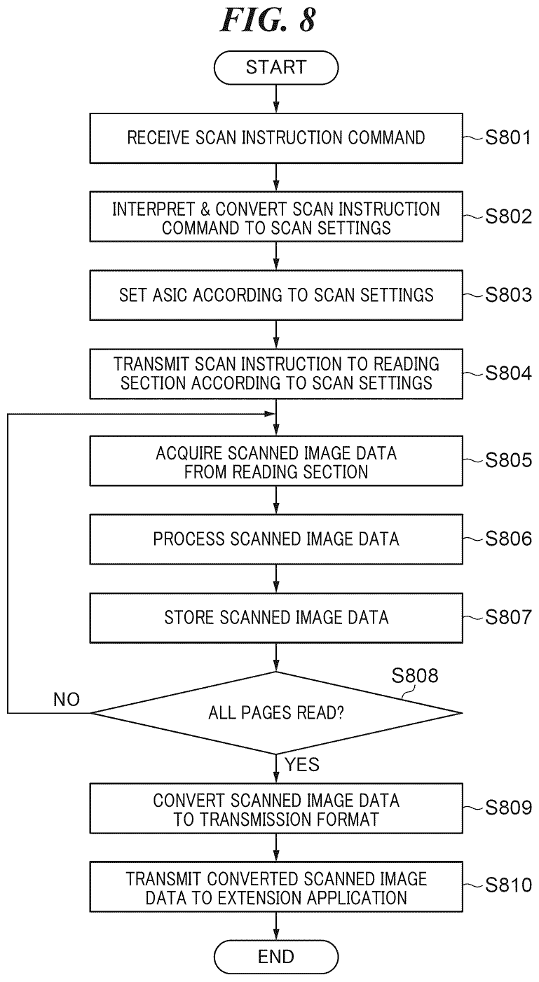

FIG. 8 is a flowchart of the process performed by the scanning device 102. A program for executing the process in FIG. 8 is stored in the external storage device 199. The CPU 191 can execute the present process by loading the program from the external storage device 199 into the RAM 192. Referring to FIG. 8, in a step S801, the CPU 191 receives the scan instruction command (see the step S615) from the extension application 204.

In a step S802, the CPU 191 interprets the scan instruction command received in the step S801. Then, the CPU 191 converts the scan instruction command to scan settings for enabling the scanning device 102 to execute scan processing, i.e. scanning under the conditions set on the detailed setting screen 300C.

In a step S803, the CPU 191 determines an application specific integrated circuit (ASIC) of the image processor 190, which is to be used to execute scanning according to the settings (scan settings) obtained in the step S802 and performs setting of the ASIC.

In a step S804, the CPU 191 transmits a scan instruction based on the scan settings to the reading section 195.

In a step S805, the CPU 191 acquires scanned image data from the reading section 195.

In a step S806, the CPU 191 controls the image processor 190 to execute image processing on the scanned image data acquired in the step S805. As the image processing, in the present embodiment, the saturation/hue adjustment is performed, for example.

In a step S807, the CPU 191 saves the scanned image data obtained in the step S806 in the external storage device 199.

In a step S808, the CPU 191 determines whether or not the scan processing has been completed with respect to all of the pages of the original to be read, i.e. scanned. If it is determined in the step S808 that the scan processing has been completed, the process proceeds to a step S809. On the other hand, if it is determined in the step S808 that the scan processing has not been completed, the process returns to the step S805, to sequentially execute the step S805 et seq.

In the step S809, the CPU 191 controls the image processor 190 to convert the scanned image data saved in the step S807 to a transmission format. In the present embodiment, the transmission format is not included in the scan instruction command received in the step S801. Therefore, the scanned image data is converted to Joint Photographic Experts Group (JPEG) as the default setting of the scanning device 102, but this is not limitative.

In a step S810, the CPU 191 controls the input/output interface 198 to transmit the scanned image data converted in the step S809 to the extension application 204, followed by terminating the present process. Note that in the present embodiment, the description has been given of the case where an original is read on the scanner bed and the saturation/hue adjustment is executed, but it is also possible to execute the saturation/hue adjustment on an original read on the feeder. Further, although in the present embodiment, in a case where there are a plurality of image data, all the image data are received and then collectively transmitted to the extension application 204, this is not limitative, but, for example, each image data can be transmitted to the extension application 204 whenever the scanned image data is received.

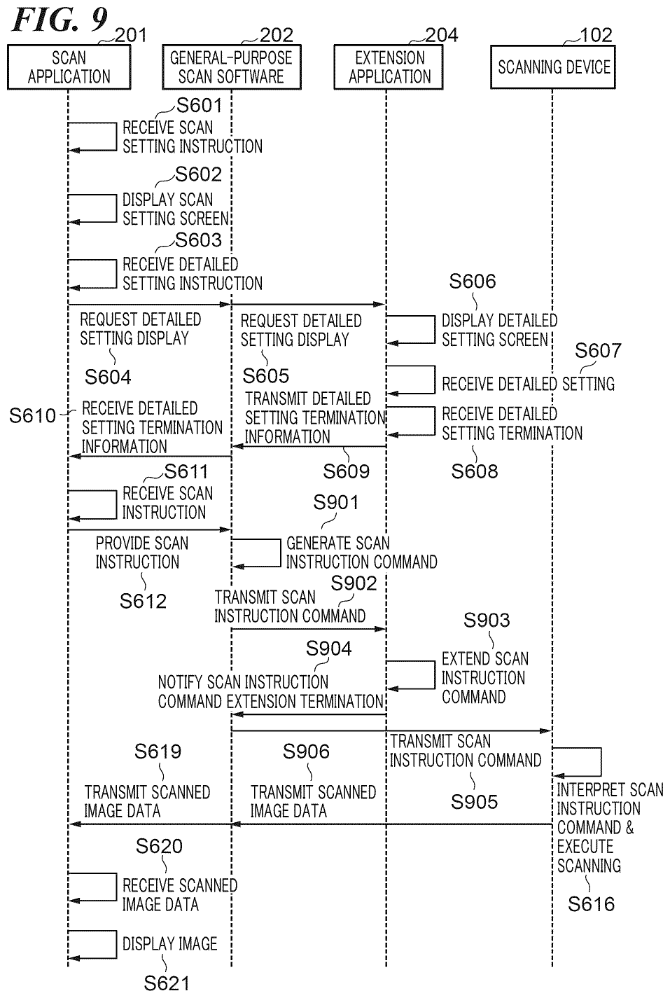

Next, a second embodiment will be described below with reference to FIG. 9, but the description will be given mainly of different points from the above-described embodiment, and description of the same points is omitted.

FIG. 9 is a sequence diagram showing a process executed between the scan application 201, the general-purpose scan software 202, the extension application 204, and the scanning device 102, after the scan application 201 receives a scan setting instruction in the second embodiment. In the sequence diagram shown in FIG. 9, differently from the sequence diagram shown in FIG. 6, after execution of the step S612, steps S901 to S905 are sequentially executed in place of the steps S613 to S615. Further, after execution of the step S616, a step S906 is executed in place of the steps S617 and S618. As shown in FIG. 9, in the step S901, the general-purpose scan software 202 receives the scan instruction provided in the step S612. Then, the general-purpose scan software 202 generates a scan instruction command based on the scan function information 203 in which the setting state on the detailed setting screen 300C has been written in the step S608. Note that this scan instruction command does not include a function which is not supported by the general-purpose scan software 202.

In the step S902, the general-purpose scan software 202 transmits the scan instruction command generated in the step S901 to the extension application 204. In the step S903, the extension application 204 receives the scan instruction command sent in the step S902. Then, the extension application 204 adds an instruction command of a function which is not supported by the general-purpose scan software 202 and changes the existing instruction for the scan instruction command. With this, the function of the scan instruction command is extended. Specifically, since the saturation/hue adjustment setting is not included in the scan instruction command generated by the general-purpose scan software 202 in the step S901, the saturation/hue adjustment setting is added in the step S903.

In the step S904, the extension application 204 notifies the general-purpose scan software 202 that extension of the function of the scan instruction command in the S903 is completed. Further, the extension application 204 transmits the scan instruction command in which the function has been extended in the step S903 to the general-purpose scan software 202.

In the step S905, the general-purpose scan software 202 receives the scan instruction command sent in the step S904. Then, the general-purpose scan software 202 transmits this scan instruction command to the scanning device 102.

In the step S906, the input/output interface 198 of the scanning device 102 transmits the scanned image data obtained in the step S616 to the general-purpose scan software 202. With this, the general-purpose scan software 202 can receive this scanned image data.

As described above, in the present embodiment, it is possible to transmit the scan instruction command in which the function of setting the saturation/hue adjustment has been extended by the extension application 204 to the scanning device 102 via the general-purpose scan software 202. As a result, it is possible to perform scanning under the saturation/hue adjustment setting.

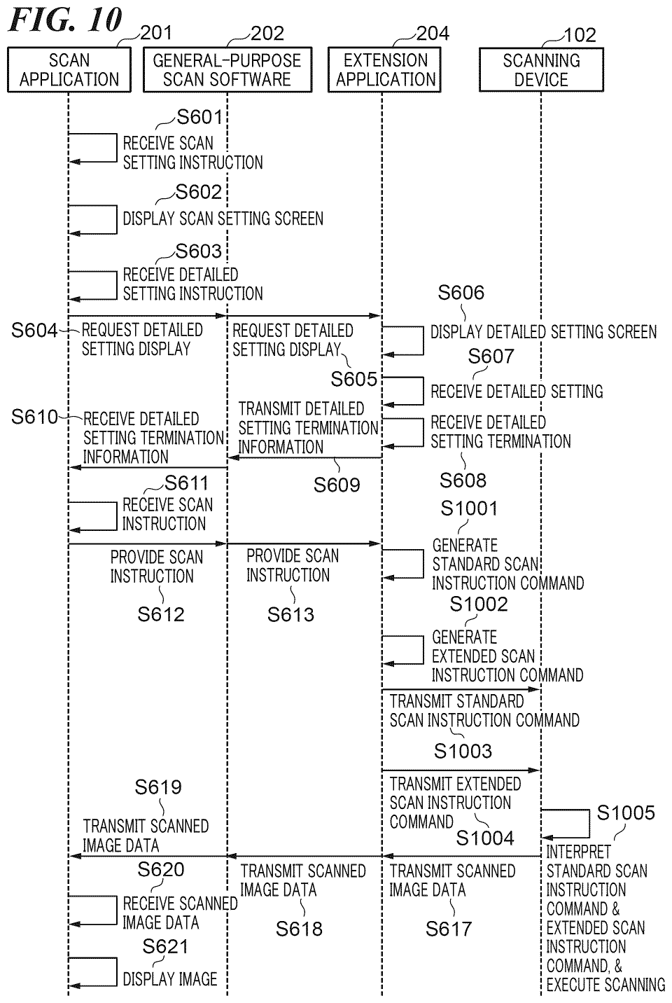

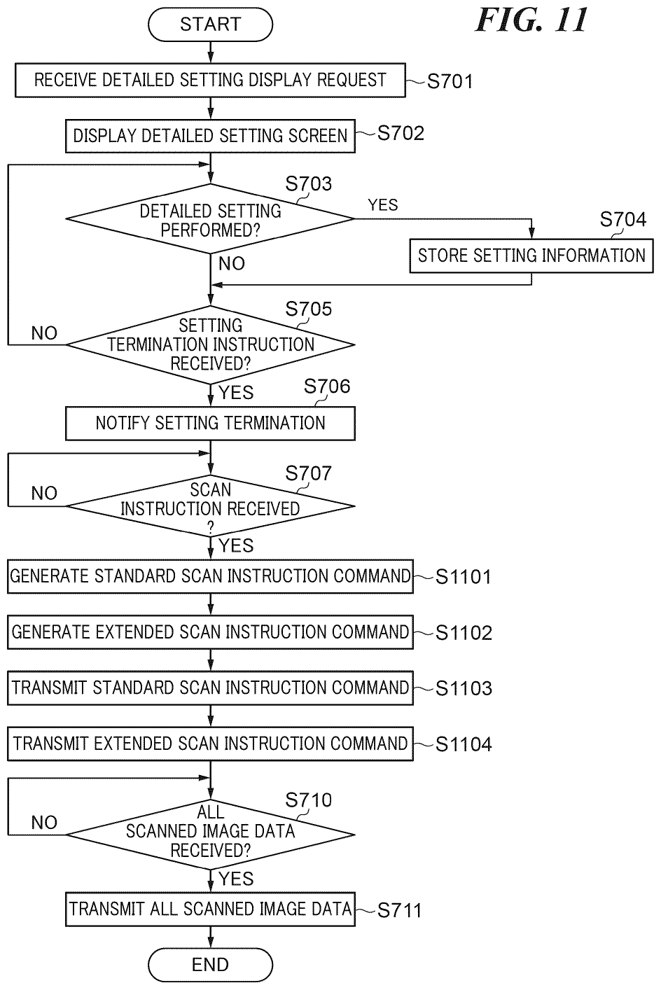

A third embodiment will be described below with reference to FIGS. 10 and 11, but the description will be given mainly of different points from the above-described embodiment, and description of the same points is omitted.

FIG. 10 is a sequence diagram showing a process executed between the scan application 201, the general-purpose scan software 202, the extension application 204, and the scanning device 102, after the scan application 201 receives a scan setting instruction in the third embodiment. In the sequence diagram shown in FIG. 10, differently from the sequence diagram shown in FIG. 6, after execution of the step S613, steps S1001 to S1005 are sequentially executed in place of the steps S614 to S616. As shown in FIG. 10, in the step S1001, the extension application 204 receives the scan instruction provided in the step S613. Then, the extension application 204 generates a standard scan instruction command according to the standard protocol. Note that this scan instruction command does not include a function which is not supported by the standard protocol.

In the step S1002, the extension application 204 generates an extended scan instruction command with respect to the function which is supported only by the extension application 204.

In the step S1003, the extension application 204 transmits the standard scan instruction command generated in the step S1001 to the scanning device 102.

In the step S1004, the extension application 204 transmits the extended scan instruction command generated in the step S1002 to the scanning device 102.

In the step S1005, the input/output interface 198 of the scanning device 102 receives the standard scan instruction command transmitted in the step S1003 and the extended scan instruction command transmitted in the step S1004. Then, the reading section 195 of the scanning device 102 interprets the standard scan instruction command and the extended scan instruction command, respectively, and executes scanning. With this, as the scanned image data, image data on which the saturation/hue adjustment has been executed is obtained.

As described above, in the present embodiment, the function of setting the saturation/hue adjustment is not extended with respect to the standard scan instruction command, but it is possible to cope with the function of setting the saturation/hue adjustment, which is supported only by the extension application 204, by using another scan instruction command. With this, it is possible to perform scanning under the saturation/hue adjustment setting.

FIG. 11 is a flowchart of the process performed by the extension application 204. In the flowchart shown in FIG. 11, differently from the flowchart shown in FIG. 7, steps S1101 to S1104 are sequentially executed in place of the steps S708 and S709. As shown in FIG. 11, in the step S1101, the extension application 204 generates a standard scan instruction command according to the standard protocol.

In the step S1102, the extension application 204 generates an extended scan instruction command with respect to a function which is not supported by the standard protocol but supported only by the extension application 204.

In the step S1103, the extension application 204 transmits the standard scan instruction command generated in the step S1101 to the scanning device 102.

In the step S1104, the extension application 204 transmits the extended scan instruction command generated in the step S1102 to the scanning device 102.

After execution of the step S1104, the process proceeds to the step S710.

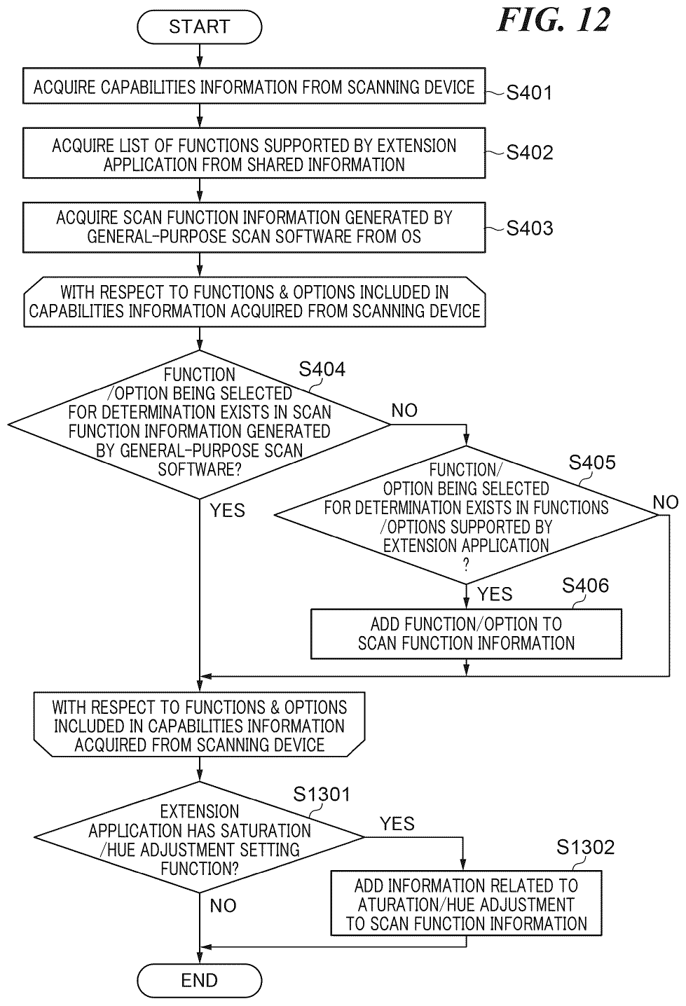

A fourth embodiment will be described below with reference to FIGS. 12 to 14, but the description will be given mainly of different points from the above-described embodiments, and description of the same points is omitted. In the first embodiment, the extension application 204 performs the saturation/hue adjustment setting in combination with the general-purpose scan software 202. Then, execution of the saturation/hue adjustment according to this setting is instructed to the scanning device 102. With this, the scanning device 102 is capable of executing the saturation/hue adjustment. Thus, in the first embodiment, the extension application 204 causes, in cooperation with the general-purpose scan software 202, the scanning device 102 to execute the saturation/hue adjustment.

However, some types of the scanning device 102 are not capable of executing the saturation/hue adjustment. In this case, even when the extension application 204 instructs execution of the saturation/hue adjustment, it is impossible to cause the scanning device 102 to execute the saturation/hue adjustment. In view of this, in the present embodiment, whether or not the scanning device 102 is capable of executing the saturation/hue adjustment is determined based on the capabilities information of the scanning device 102. As a result of this determination, if it is determined that the scanning device 102 is capable of executing the saturation/hue adjustment, the extension application 204 causes the scanning device 102 to execute the saturation/hue adjustment. On the other hand, if it is determined that the scanning device 102 is incapable of executing the saturation/hue adjustment, the extension application 204 executes the saturation/hue adjustment. With this, even in a case where the scanning device 102 is incapable of executing the saturation/hue adjustment, it is possible to provide the saturation/hue adjustment to the user.

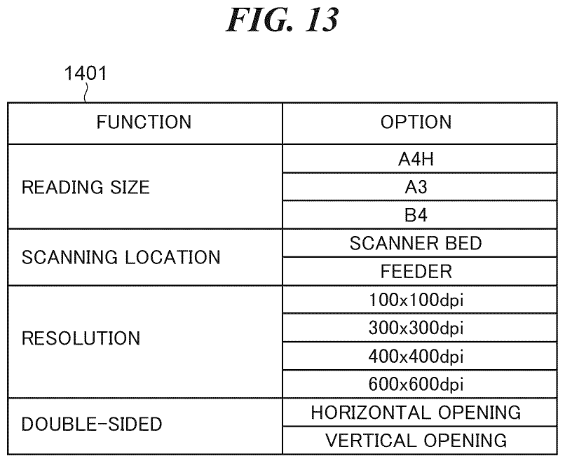

FIG. 12 is a flowchart of a process performed for editing the scan function information, by the scan function-extending unit 206 in the fourth embodiment. Note that a program for the process in FIG. 12 is executed by the scan function-extending unit 206 under the control of the CPU 111. Further, the process in FIG. 12 is configured such that steps S1301 and S1302 are added to the process in FIG. 4. FIG. 13 is a diagram showing an example of a list of the capabilities information of the scanning device 102. As shown in FIG. 12, in a case where the process for repeating the steps S404 to S406 is terminated, the process proceeds to the step S1301. A table 1401 shown in FIG. 13 indicates a list of the capabilities information of the scanning device 102. This table 1401 includes, as the capabilities information, information related to a reading size, information related to a scanning location, information related to resolution, and information related to double-sided printing, but differently from the table 501 shown in FIG. 5A, information related to the saturation/hue adjustment is not included. This indicates that the scanning device 102 is incapable of executing the saturation/hue adjustment. Therefore, in the scan function information 203 after execution of the processing operations in the steps S404 to S406, the saturation/hue adjustment setting function is not added.

As shown in FIG. 12, in the step S1301, the scan function-extending unit 206 determines whether or not the extension application 204 has the saturation/hue adjustment setting function. If it is determined in the step S1301 that the extension application 204 has the saturation/hue adjustment setting function, the process proceeds to the step S1302. On the other hand, if it is determined in the step S1301 that the extension application 204 does not have the saturation/hue adjustment setting function, the present process is terminated. As described above, since the extension application 204 has the saturation/hue adjustment setting function, the process proceeds to the step S1302.

In the step S1302, the scan function-extending unit 206 adds the information related to the saturation/hue adjustment in the table 501 shown in FIG. 5A to the scan function information 203.

As described above, the extension application 204 can add, to the scan function information 203, a function which is not supported by the general-purpose scan software 202 but is supported by the scanning device 102, and at the same time can be supported by the extension application 204. Then, the scan function-extending unit 206 determines whether or not the extension application 204 has the saturation/hue adjustment setting function. As a result of this determination, if it is determined that extension application 204 has the saturation/hue adjustment setting function, the saturation/hue adjustment setting function is added to the scan function information 203. With this addition processing, even when the scanning device 102 is incapable of executing the saturation/hue adjustment, the capabilities information is generated based on the scan function information 203 to which the saturation/hue adjustment has been added. The extension application 204 can display the detailed setting screen 300C shown in FIG. 3C by generating a display screen based on this capabilities information.

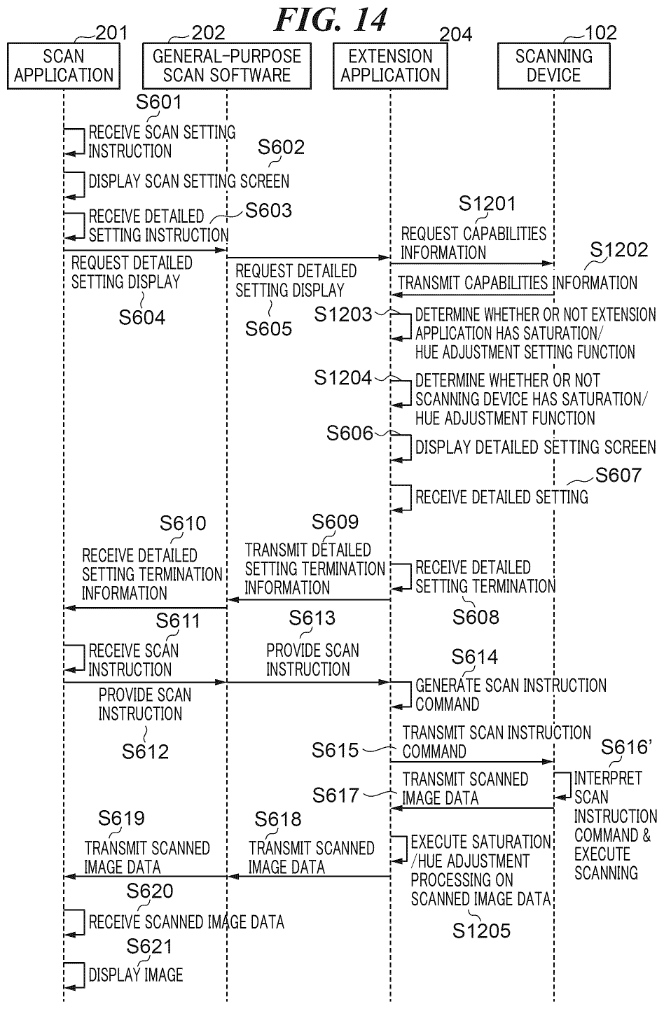

FIG. 14 is a sequence diagram showing a process executed between the scan application 201, the general-purpose scan software 202, the extension application 204, and the scanning device 102 after the scan application 201 receives a scan setting instruction. In the sequence diagram shown in FIG. 14, differently from the sequence diagram shown in FIG. 6, steps S1201 to S1204 are sequentially executed between the steps S605 and S606. Further, a step S1205 is executed between the steps S617 and S618. As shown in FIG. 14, in the step S1201, the scan function-extending unit 206 of the extension application 204 requests the capabilities information to the scanning device 102.

In the step S1202, the scanning device 102 transmits the capabilities information to the scan function-extending unit 206 in response to the capabilities information request received in the step S1201. With this, the scan function-extending unit 206 acquires the capabilities information from the scanning device 102.

In the step S1203, the scan function-extending unit 206 acquires a list of the scan functions supported by the extension application 204 from the shared information 208 and determines whether or not the saturation/hue adjustment setting function is included in this list.

In the step S1204, the scan function-extending unit 206 determines, based on the capabilities information acquired in the step S1202, whether or not the scanning device 102 has the saturation/hue adjustment function. In the present embodiment, the scanning device 102 does not have the saturation/hue adjustment function, and hence it is determined in the step S1204 that the scanning device 102 does not have the saturation/hue adjustment function. Note that if it is determined in the step S1204 that the scanning device 102 has the saturation/hue adjustment function, execution of the step S1205 is omitted. This is because, in general, the scanning device 102 is capable of executing the saturation/hue adjustment at higher speed than the image data-editing unit 207. Specifically, the scanning device 102 is capable of executing the saturation/hue adjustment at higher speed than the image data-editing unit 207 by using the ASIC.

In the step S1205, the image data-editing unit 207 of the extension application 204 executes the saturation/hue adjustment on the image data received from the scanning device 102 according to the settings, received on the detailed setting screen 300C (execution step), of the saturation/hue adjustment. As a result, image data on which the saturation/hue adjustment has been executed is obtained, i.e. generated. Note that, differently from the step S616 in the first embodiment, in a step S616′ in the present embodiment, the saturation/hue adjustment is not executed.

Then, in the step S618 after execution of the step S1205, the extension application 204 transmits the image data obtained in the step S1205, i.e. a result of execution in the execution step to the general-purpose scan software 202 (transmission step).

As described above, in the present embodiment, even when the saturation/hue adjustment is incapable of being executed by the scanning device 102, it is possible to execute the saturation/hue adjustment by using the extension application 204.

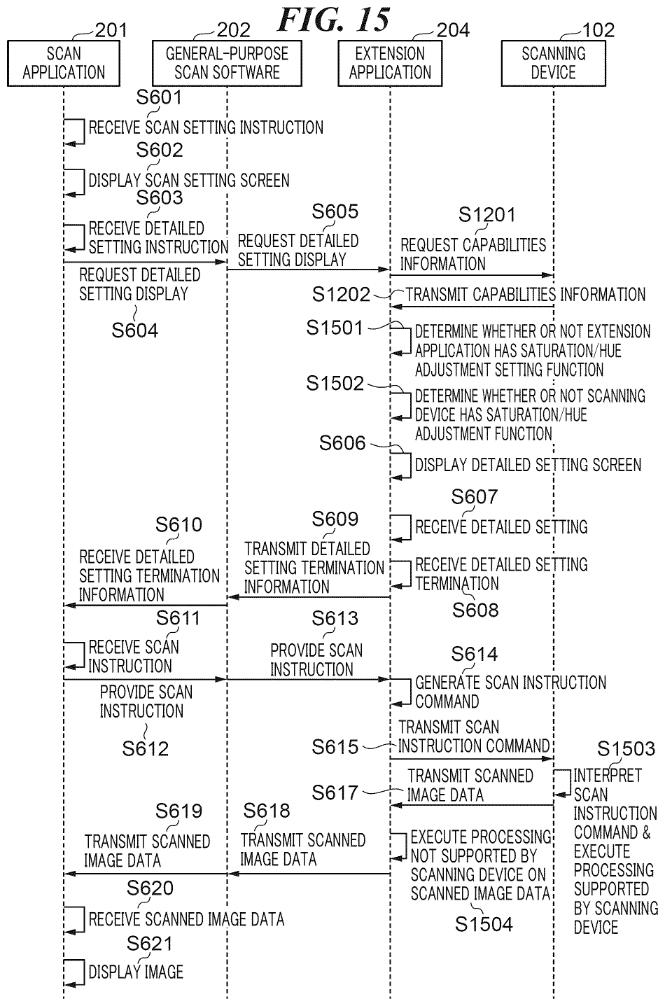

A fifth embodiment will be described below with reference to FIG. 15, but the description will be given mainly of different points from the above-described embodiments, and description of the same points is omitted. Depending on the scanning device 102, it is possible to execute one of the saturation adjustment function and the hue adjustment function, but impossible to execute the other. In this case, it is possible to execute both of the saturation adjustment function and the hue adjustment function by the extension application 204 (hereinafter referred to as a first execution pattern). Besides this, it is also possible to execute, out of the saturation adjustment function and the hue adjustment function, a function which can be executed by the scanning device 102, by the scanning device 102, and a function which cannot be executed by the scanning device 102, by the application 204 (hereinafter referred to as a second execution pattern). The second execution pattern is more preferrable than the first execution pattern, because, in general, it tends to be possible to execute, out of the saturation adjustment function and the hue adjustment function, the function which can be executed by the scanning device 120, by the same, at a higher speed than when executing the function by the extension application 204. Therefore, in the present embodiment, the second execution pattern will be described.

FIG. 15 is a sequence diagram showing a process executed in the fifth embodiment between the scan application 201, the general-purpose scan software 202, the extension application 204, and the scanning device 102, after the scan application 201 receives a scan setting instruction. Differently from the sequence diagram shown in FIG. 14, in place of the steps S1203 and S1204, a step S1501 and a step S1502 are sequentially executed. Further, differently from the sequence diagram shown in FIG. 14, in the sequence diagram shown in FIG. 15, in place of the step S616′, a step S1503 is executed, and in place of the step S1205, a step S1504 is executed. Further, in the present embodiment, it is assumed that, out of the saturation adjustment function and the hue adjustment function, the saturation adjustment function is executed by the scanning device 102, and the hue adjustment function is executed by the extension application 204, by way of example. Referring to FIG. 15, in the step S1501, the scan function-extending unit 206 of the extension application 204 acquires a list of scan functions supported by the extension application 204, from the shared information 208, and determines whether or not the saturation/hue adjustment setting function is included in the list.

In the step S1502, the scan function-extending unit 206 determines from the capabilities information, whether or not a saturation/hue adjustment function is included in the scanning device 102, i.e. whether or not the scanning device 102 is capable of performing the saturation adjustment and the hue adjustment. In the present embodiment, it is determined that the scanning device 102 is capable of performing the saturation adjustment and is incapable of performing the hue adjustment.

In the step S1503, the scanning device 102 executes the saturation adjustment on the image data read by the reading section 195.

In the step S1504, the image data-editing unit 207 of the extension application 204 executes the hue adjustment which the scanning device 102 is determined to be incapable of executing, on the scanned image data. Thus, in the present embodiment, the second execution pattern is made executable.

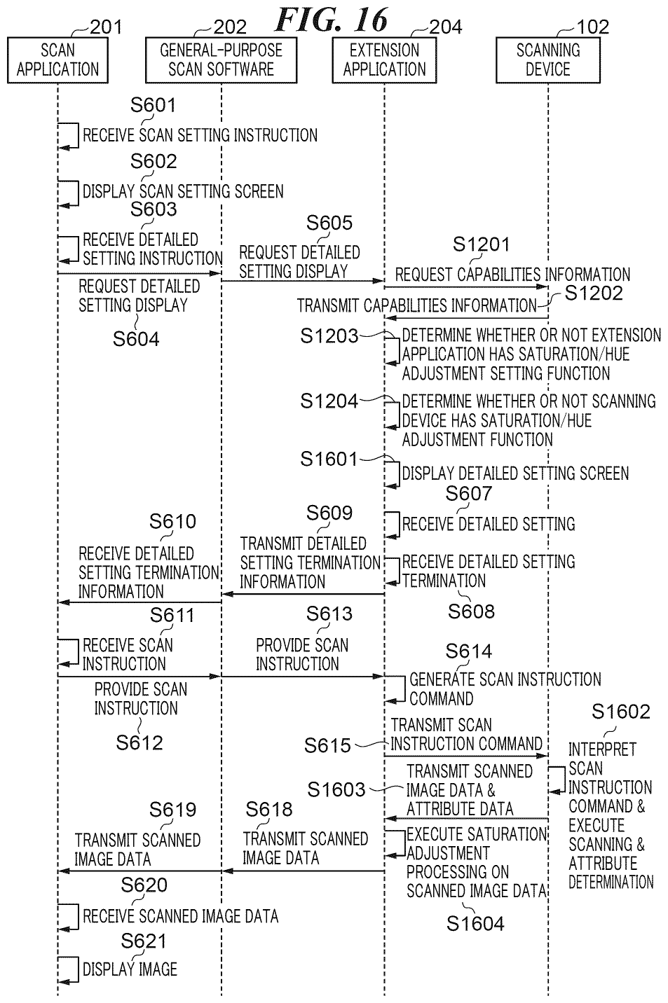

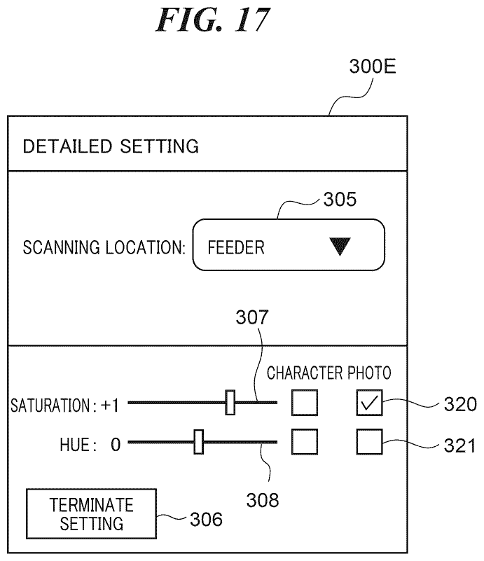

Hereafter, a six embodiment will be described with reference to FIGS. 16 and 17. The description will be given mainly of different points from the above-described embodiment, and the same points are omitted from the description. When executing the saturation/hue adjustment on image data, besides setting the entire image to an execution target, it is sometimes desired to set part of the image to an execution target. For example, in a case where photographs and characters are mixed in an image, it is desired to execute the saturation/hue adjustment on photograph portions, while leaving the colors of the characters as they are. In this case, determination is performed on objects included in the image, and based on a result of the determination, the saturation/hue adjustment can be executed on the photograph portions. Note that the objects refer to attributes, such as photographs, characters, and a background, which are included in the image. Further, the attributes can be set for the image data on a pixel by pixel basis, or on a specific area basis. In general, the object determination processing is often executed by combining filtering, pattern determination, and the like, which makes the processing amount relatively large. In view of this, the object determination processing is preferably executed by a dedicated processing module.

Accordingly, in the present embodiment, the object determination processing is executed by a dedicated processing module of the scanning device 102. Then, attributes data as a result of the object determination processing, is transmitted together with the image data, to the extension application 204 to thereby execute the saturation/hue adjustment function. Note that, the object determination processing can be executed by the extension application 204.

FIG. 16 is a sequence diagram showing a process executed, in the sixth embodiment, between the scan application 201, the general-purpose scan software 202, the extension application 204, and the scanning device 102, after the scan application 201 receives a scan setting instruction. In the sequence diagram shown in FIG. 16, differently from the sequence diagram shown in FIG. 14, in place of the step S606, a step S1601 is executed. Further, in the sequence diagram shown in FIG. 16, differently from the sequence diagram shown in FIG. 14, in place of the steps S616′, S617, and S1205, steps S1602 to S1604 are sequentially executed. FIG. 17 is an example of a screen displayed on the display section 119 of the scan system 1000. Referring to FIG. 16, in the step S1601, the scan setting screen-extending unit 205 of the extension application 204 displays a detailed setting screen 300E shown in FIG. 17 on the display section 119. Similar to the detailed setting screen 300C, the detailed setting screen 300E includes the control 305 to the hue adjustment slide bar 308. Further, the detailed setting screen 300E additionally includes a check box (designation section) 320, a check box (designation section) 321. The check box 320 enables selection (designation) of at least one of character and photograph as an object of saturation adjustment. The check box 321 enables selection of at least one of character and photograph as an object of hue adjustment. FIG. 17 shows an example in which photograph is selected in the check box 320 and none of character and photograph is selected in the check box 321. Note that the choices in the check boxes 320 and 321 can include other objects including a background. Further, in place of the check boxes 320 and 321, targets to be subjected to the adjustments can be displayed in the form of a list.

In the step S1602, the scanning device 12 interprets the scan instruction command and performs the scan processing as well as the attribute determination processing. In the attribute determination processing, for example, edge extraction processing is executed, for example, on the image data, and pattern determination is performed on edge information extracted by the edge extraction processing. Then, whether or not determination of a character or a non-character (photograph) can be determined on a pixel-by-pixel basis, whereby attribute data can be generated, or attribute data can be added to specific areas by labelling processing or the like.

In the step S1603, the scanning device 102 transmits image data read by the reading section 195 and the attribute data acquired in the step S1602 to the extension application 204.

In the step S1604, the image data-editing unit 207 of the extension application 204 executes the saturation/hue adjustment only on the objects set as targets of the saturation/hue adjustment, based on the image data and attributes data transmitted in the step S1603. Thus, in the present embodiment, it is possible to set part of the image to an execution target when executing the saturation/hue adjustment on image data.

According to the present disclosure, it is possible to perform adjustment of saturation and hue on an image generated by the scan function.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-165077 filed Sep. 24, 2024, which is hereby incorporated by reference herein in its entirety.

What is claimed is:

1. A non-transitory computer-readable storage medium storing an application program supporting a standard driver which has been supplied from a supplier of an operating system and has been incorporated in the operating system in advance,
wherein the application program causes a computer to execute:
a display control step of displaying a setting reception screen for receiving a setting of saturation of an image generated by a scan function of the image processing apparatus; and
an output step of outputting the setting received on the setting reception screen.

2. The storage medium according to claim 1, wherein the setting reception screen includes a saturation adjustment portion for adjusting the saturation.

3. The storage medium according to claim 2, wherein the setting reception screen is capable of receiving a setting of hue of the image, and
wherein the setting reception screen includes a hue adjustment portion for adjusting the hue.

4. The storage medium according to claim 1, wherein a range within which the setting can be made has an upper limit and a lower limit provided therefor.

5. The storage medium according to claim 1, wherein the setting reception screen includes a preview image of the image at least after the setting, out of the image before the setting and the image after the setting.

6. The storage medium according to claim 1, wherein the setting reception screen is configured to be capable of receiving the setting for part of the image.

7. The storage medium according to claim 6, wherein the setting reception screen includes a designation section for specifying part of the image.

8. The storage medium according to claim 1, wherein the application program is capable of switching whether to display the setting reception screen or not, depending on the image processing apparatus.

9. The storage medium according to claim 8, wherein the application program causes the computer to execute:
an acquisition step of acquiring capabilities information related to capabilities of executing the scan function from the image processing apparatus, before the display control step, and
a determination step of determining whether or not information enabling the setting reception screen to be displayed is included in the capabilities information acquired by the acquisition step, and
wherein in the display control step, in a case where, as a result of the determination step, it is determined that information enabling the setting reception screen to be displayed is included, the setting reception screen is displayed, and in a case where it is determined that the information enabling the setting reception screen to be displayed is not included, the setting reception screen is not displayed.

10. The storage medium according to claim 1, wherein the function of receiving the setting is a function incapable of being executed by the standard driver.

11. The storage medium according to claim 1, wherein as the standard driver, a program operating based on Internet Printing Protocol (IPP) is used.

12. A non-transitory computer-readable storage medium storing an application program supporting a standard driver which has been supplied from a supplier of an operating system and has been incorporated in the operating system in advance,
wherein the application program causes a computer to execute:
a display control step of displaying a setting reception screen for receiving a setting of saturation of an image generated by a scan function of the image processing apparatus;
an acquisition step of acquiring the image generated by the scan function from the image processing apparatus; and
an execution step of executing processing based on the setting received on the setting reception screen, on the image acquired in the acquisition step.

13. A method for supporting a standard driver which has been supplied from a supplier of an operating system and has been incorporated in the operating system in advance, the method comprising:
a display control step of displaying a setting reception screen for receiving a setting of saturation of an image generated by a scan function of the image processing apparatus; and
an output step of outputting the setting received on the setting reception screen.
